(19) United States
(12) Patent Application Publication
(10) Pub. No.: US 2026/0219534 A1
(43) Pub. Date: Jul. 30, 2026

(54) LIQUID CRYSTAL LIGHT CONTROL DEVICE

(71) Applicant: Japan Display Inc., Tokyo (JP)

(72) Inventors: Koichi IGETA, Tokyo (JP); Shinichiro OKA, Tokyo (JP); Takeo KOITO, Tokyo (JP)

(21) Appl. No.: 19/436,867

(22) Filed: Dec. 30, 2025

Related U.S. Application Data
(63) Continuation of application No. PCT/JP2024/017551, filed on May 13, 2024.

(30) Foreign Application Priority Data
Jul. 27, 2023 (JP) 2023-122764

(51) Int. Cl. G02F 1/1337

(52) U.S. Cl. CPC G02F 1/133788; G02F 1/133723

(57) ABSTRACT

A liquid crystal light control device includes a pair of substrates, a pair of alignment films between the pair of substrates, and a liquid crystal layer between the pair of alignment films, wherein each of the pair of substrates is provided with an electrode, and at least one of the pair of alignment films has a transmittance of 98% or more at a wavelength of 450 nm. A varnish forming the alignment films may include a solid component and a solvent component, the solid component may include a coloring material, and a content ratio of the coloring material to the total solid component is less than 10 mol %.

### CROSS-REFERENCE TO RELATED APPLICATIONS

This application is a Continuation of International Patent Application No. PCT/JP2024/17551, filed on May 13, 2024, which claims the benefit of priority to Japanese Patent Application No. 2023-122764, filed on Jul. 27, 2023, the entire contents of which are incorporated herein by reference.

### FIELD

An embodiment of the present invention relates to a liquid crystal light control device that utilizes the electro-optical effect of liquid crystals to control the light distribution emitted from a light source.

### BACKGROUND

A technique is known for controlling the light distribution emitted from a light source using a liquid crystal lens. For example, it has been disclosed that opposing pairs of substrates each have an alignment film for aligning the liquid crystal, and the alignment directions of the liquid crystals are orthogonal (twisted at 90 degrees) (see International Patent publication No. 2010/230887).

The liquid crystal light control device used for illumination is exposed to intense light. When the alignment film is exposed to strong light for extended periods, the film itself absorbs the light, and the absorbed light energy causes degradation.

Specifically, degradation of the alignment film weakens its ability to control the alignment of the liquid crystals. After applying an electric field to drive the liquid crystals and then removing the field, the liquid crystals fail to return to their initial alignment state, resulting in locally reversed twist directions (reverse twist). As a result, the liquid crystal alignment becomes locally disordered. When light emitted from the light source passes through this disordered liquid crystal, it becomes scattered. This leads to a defect where the desired characteristics cannot be achieved when used for illumination.

### SUMMARY

A liquid crystal light control device according to an embodiment of the present invention includes a pair of substrates, a pair of alignment films between the pair of substrates, and a liquid crystal layer between the pair of alignment films. Each of the pair of substrates is provided with an electrode, and at least one of the pair of alignment films has a transmittance of 98% or more at a wavelength of 450 nm.

### BRIEF DESCRIPTION OF DRAWINGS

FIG. 1 shows an outline of a liquid crystal light control device according to an embodiment of the present invention.

FIG. 2 is a perspective view of a liquid crystal panel constituting a liquid crystal light control element according to an embodiment of the present invention.

FIG. 3A shows an electrode structure of a liquid crystal panel constituting a liquid crystal light control element according to an embodiment of the present invention.

FIG. 3B shows an electrode structure of a liquid crystal panel constituting a liquid crystal light control element according to an embodiment of the present invention.

FIG. 4A is a diagram for explaining an operation of a liquid crystal panel constituting a liquid crystal light control element according to an embodiment of the present invention.

FIG. 4B is a diagram for explaining the operation of the liquid crystal panel constituting the liquid crystal light control element according to the embodiment of the present invention.

FIG. 5 is a diagram for explaining a voltage applied to a liquid crystal panel constituting a liquid crystal light control element according to an embodiment of the present invention and a state of light distribution control by the voltage.

FIG. 6 is a diagram for explaining an example of light distribution control by the liquid crystal light control element according to the embodiment of the present invention.

FIG. 7 is a diagram showing an absorption spectrum of the alignment film of Example 1.

FIG. 8 is a diagram showing an absorption spectrum of an alignment film of Comparative Example 1.

### DESCRIPTION OF EMBODIMENTS

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but the drawings are only an example and do not limit the interpretation of the present invention. In this specification and each drawing, elements similar to those described previously with respect to previous drawings may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

As used herein, “light distribution” refers to the spread of light emitted from a light source, specifically the distribution of luminous intensity (light strength) in each direction, as understood in its usual meaning. Controlling a light distribution means intentionally controlling the spread of light emitted from the light source.

In the present specification, “optical rotation” refers to the phenomenon whereby the polarization axis of a linear polarization component rotates as light passes through the liquid crystal layer.

In the present specification, the “alignment direction” of an alignment film refers to the direction in which liquid crystal molecules align when a process imparting an alignment control force (e.g., rubbing or photo-alignment) is performed to align liquid crystal molecules on the alignment film. When the treatment applied to the alignment film is rubbing, the alignment direction of the alignment film is typically the rubbing direction. Alternatively, when the treatment applied to the alignment film utilizes a photoreaction employing polarized ultraviolet light (e.g., photoalignment), the alignment direction of the alignment film after irradiation with polarized ultraviolet light is perpendicular to the polarization direction due to photodecomposition.

In the present specification, the “extended direction” of a strip electrode refers to the direction in which the longer side of the pattern extends when viewing the strip electrode in a plan view, where the pattern has a shorter side (width) and a longer side (length).

### 1. Overview of the Liquid Crystal Light Control Device

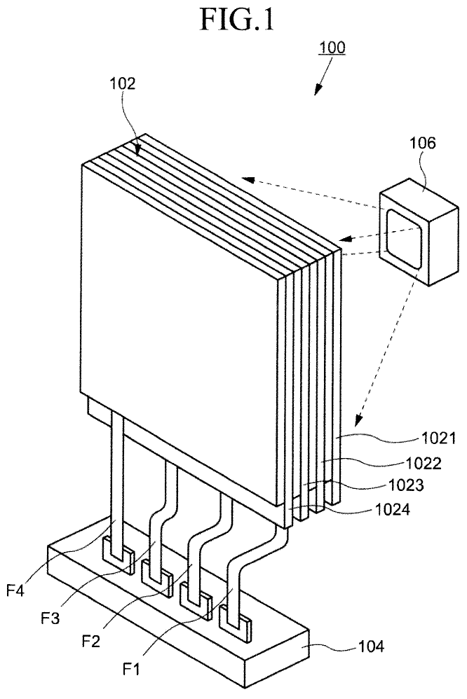

FIG. 1 is a perspective view showing the configuration of a liquid crystal light control device 100 according to an embodiment of the present invention. The liquid crystal light control device 100 includes a liquid crystal light control element 102 and a control circuit 104. The liquid crystal light control element 102 is composed of a plurality of liquid crystal panels. FIG. 1 shows an example where the liquid crystal light control element 102 comprises a first liquid crystal panel 1021, a second liquid crystal panel 1022, a third liquid crystal panel 1023, and a fourth liquid crystal panel 1024.

The first liquid crystal panel 1021, the second liquid crystal panel 1022, the third liquid crystal panel 1023, and the fourth liquid crystal panel 1024 are flat-panel devices. The liquid crystal light control element 102 has a structure wherein the flat surfaces of the first liquid crystal panel 1021, the second liquid crystal panel 1022, the third liquid crystal panel 1023, and the fourth liquid crystal panel 1024 are arranged to overlap. The first liquid crystal panel 1021 and the second liquid crystal panel 1022, the second liquid crystal panel 1022 and the third liquid crystal panel 1023, and the third liquid crystal panel 1023 and the fourth liquid crystal panel 1024 are bonded together using a transparent adhesive (not shown).

The liquid crystal light control element 102 is driven by the control circuit 104. In other words, control signals for driving each liquid crystal panel are output from the control circuit 104. As shown in FIG. 1, the control circuit 104 is connected to the first liquid crystal panel 1021 via the first flexible wiring substrate F1, connected to the second liquid crystal panel 1022 via the second flexible wiring substrate F2, connected to the third liquid crystal panel 1023 via the third flexible wiring substrate F3, and connected to the fourth liquid crystal panel 1024 via the fourth flexible wiring substrate F4.

The liquid crystal light control device 100 has the function of controlling the spread of light emitted from the light source 106, specifically the luminous intensity distribution of light spreading in a predetermined direction. The light source 106 is positioned on the rear side of the liquid crystal light control element 102. Light emitted from the light source 106 passes through the liquid crystal light control element 102 and is emitted to the outside (illumination space). When light emitted from the light source 106 is irradiated onto the liquid crystal light control element 102, the light passes sequentially through the first liquid crystal panel 1021, the second liquid crystal panel 1022, the third liquid crystal panel 1023, and the fourth liquid crystal panel 1024 before being emitted to the outside.

The configuration of the light source 106 is not limited. The light source 106 may comprise components such as a light-emitting body, e.g., a light-emitting diode, halogen lamp, tungsten lamp, mercury lamp, or fluorescent lamp, and a reflector. The light source 106 may be a white light source or a light source emitting a color-tuned light such as daylight white or incandescent white. An optical element, such as a lens, may be provided between the light source 106 and the liquid crystal light control element 102.

As described in detail below, the liquid crystal light control device 100 has the function of controlling the spread of light emitted from the light source 106 using the liquid crystal light control element 102. The liquid crystal light control element 102 has the function of forming light distribution patterns such as square shapes, cross shapes, or line shapes on the irradiation surface using the light emitted from the light source 106, based on the control voltage output from the control circuit 104.

### 2. Liquid Crystal Panel

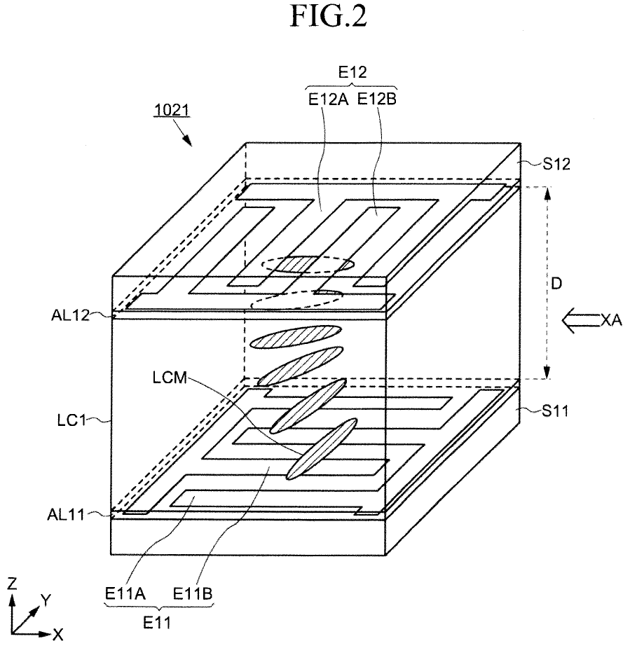

FIG. 2 shows a perspective view of the first liquid crystal panel 1021 constituting the liquid crystal light control element 102. FIG. 2 indicates the X, Y, and Z axis directions for explanatory purposes. The X-axis direction and the Y-axis direction are orthogonal to each other in a plan view, and the Z-axis direction extends in a direction normal to the X-Y plane. In the following description, expressions such as the X-axis direction, Y-axis direction, and Z-axis direction are used to specify directions. However, these expressions can also be replaced with expressions such as the first direction for the X-axis direction, the second direction for the Y-axis direction, the third direction for the Z-axis direction, or the up-down direction.

The first liquid crystal panel 1021 includes a first substrate S11, a second substrate S12, a first electrode E11, a second electrode E12, a first alignment film AL11, a second alignment film AL12, and a first liquid crystal layer LC1. The first substrate S11 has the first electrode E11 and the first alignment film AL11 provided thereon, and the second substrate S12 has the second electrode E12 and the second alignment film AL12 provided thereon. The first alignment film AL11 is provided to cover the first electrode E11, and the second alignment film AL12 is provided to cover the second electrode E12. The first substrate S11 and the second substrate S12 are spaced apart and arranged facing each other. Furthermore, the first electrode E11 and the second electrode E12 are disposed within the inner surface plane where the first substrate S11 and the second substrate S12 face each other. The first liquid crystal layer LC1 is provided between the first substrate S11 and the second substrate S12.

The first electrode E11 comprises a first strip electrode E11A and a second strip electrode E11B, each having a plurality of strip patterns. The second electrode E12 comprises a third strip electrode E12A and a fourth strip electrode E12B, each having a plurality of strip patterns. The first strip electrode E11A and the second strip electrode E11B are alternately arranged on the insulating surface of the first substrate S11, and the third strip electrode E12A and the fourth strip electrode E12B are alternately arranged on the insulating surface of the second substrate S12.

The plurality of strip patterns of the first strip electrode E11A and the second strip electrode E11B extend in the X-axis direction along their longitudinal direction. The plurality of strip patterns of the third strip electrode E12A and the fourth strip electrode E12B extend in the Y-axis direction along their longitudinal direction. Therefore, the direction in which the plurality of strip patterns of the first strip electrode E11A and the second strip electrode E11B extend is orthogonal (intersects at 90 degrees) to the direction in which the plurality of strip patterns of the third strip electrode E12A and the fourth strip electrode E12B extend. The relative arrangement between the first strip electrode E11A and the second strip electrode E11B and the third strip electrode E12A and the fourth strip electrode E12B is not limited to an orthogonal relationship and may be altered within a range of ±10 degrees relative to 90 degrees.

Furthermore, each strip pattern of these strip electrodes may extend in a predetermined direction while being partially bent. In this case, the strip pattern will have a plurality of extension directions along its longitudinal axis, but each extension direction may be tilted by approximately ±10 degrees relative to the X-axis or Y-axis. Similarly, the strip patterns of the strip electrodes may also adopt a configuration where they extend in a predetermined direction while being partially curved. In this case, the tangential direction at each position of the strip pattern is considered the direction of extension, and each direction of extension may be inclined within a range of approximately ±10 degrees relative to the X-axis direction or the Y-axis direction.

Furthermore, the direction in which the plurality of strip patterns constituting the first strip electrode E11A and the second strip electrode E11B extend may be inclined within a range of 30±10 degrees to 60±10 degrees relative to the X-axis direction. Similarly, the direction in which the plurality of strip patterns constituting the third strip electrode E12A and the fourth strip electrode E12B extend may be inclined at an angle within the range of 30±10 degrees to 60±10 degrees relative to the Y-axis direction.

The alignment direction ALD1 of the first alignment film AL11 is aligned in a direction (Y-axis direction) intersecting the direction in which the first strip electrode E11A and the second strip electrode E11B extend. The alignment direction ALD2 of the second alignment film AL12 is directed in the direction (X-axis direction) intersecting the direction in which the third strip electrode E12A and the fourth strip electrode E12B extend. The angle between the direction in which the first strip electrode E11A and the second strip electrode E11B extend and the alignment direction ALD1, and the angle between the direction in which the third strip electrode E12A and the fourth strip electrode E12B extend and the alignment direction ALD2, can be set within the range of 90±10 degrees.

The first substrate S11 and the second substrate S12 are arranged facing each other with a gap of 10 μm or more. For example, the first substrate S11 and the second substrate S12 are arranged with a gap of 10 μm or more and 1000 μm or less, preferably 20 μm or more and 500 μm or less. The first liquid crystal layer LC1 provided between the first substrate S11 and the second substrate S12 has a thickness D. A first electrode E11 and a second electrode E12, as well as a first alignment film AL11 and a second alignment film AL12, are provided between the first substrate S11 and the second substrate S12. However, the film thickness of these components is negligible compared to the spacing between the first substrate S11 and the second substrate S12. Therefore, the distance between the first substrate S11 and the second substrate S12 can be considered equivalent to the thickness D of the first liquid crystal layer LC1. That is, the thickness D of the first liquid crystal layer LC1 can be considered to have a value of 10 μm or more and 1000 μm or less, preferably 20 μm or more and 500 μm or less. Although not shown in FIG. 2, a spacer may be provided between the first substrate S11 and the second substrate S12.

As the liquid crystal material forming the first liquid crystal layer LC1, twisted nematic (TN) liquid crystal is used, for example. As schematically shown in FIG. 2, liquid crystal molecules possess elongated rod-like structures due to their molecular structure. The physical properties of these rod-like liquid crystal molecules differ between the long axis direction (parallel to the molecular long axis) and the short axis direction (perpendicular to the molecular long axis). Specifically, they exhibit dielectric anisotropy as a difference in electrical properties and refractive index anisotropy as a difference in optical properties. In liquid crystal displays, an alignment film is provided to regularly align liquid crystal molecules possessing these physical properties. Similarly, in the liquid crystal panel constituting the liquid crystal light control device 102, a first alignment film AL11 and a second alignment film AL12 are provided to control the alignment direction of the liquid crystal molecules.

At least one of the first alignment film AL11 and the second alignment film AL12 has a transmittance of 98% or more at a wavelength of 450 nm. In this case, the thickness of at least one of the first alignment film AL11 and the second alignment film AL12 is preferably 20 nm or more and 200 nm or less, and more preferably 40 nm or more and 150 nm or less. Since the first alignment film AL11 and the second alignment film AL12 absorb less short-wavelength light with high-energy, when short-wavelength light with high energy is emitted from the light source, absorption of that light in the first alignment film AL11 and the second alignment film AL12 is minimized. Since the absorption of short-wavelength light with high-energy in the first alignment film AL11 and the second alignment film AL12 is suppressed, degradation of the first alignment film AL11 and the second alignment film AL12 is also suppressed, preventing a decrease in the force that controls the alignment of the liquid crystal relative to the first alignment film AL11 and the second alignment film AL12.

The first alignment film AL11 and the second alignment film AL12 can be formed by applying polyamide acid or polyamide acid ester onto a substrate, baking it to form a film, and then performing an alignment process on that film. The alignment process for the first alignment film AL11 and the second alignment film AL12 is performed, as described above, by rubbing or by irradiating with polarized ultraviolet light. Herein, the alignment film to be subjected to the alignment treatment by rubbing (rubbing process) will be described.

The alignment film for the rubbing processing can be formed of varnish. The varnish may contain a solid component and a solvent component. The varnish may be composed of a solid component and a solvent component.

The solvent component includes a good solvent and an application-improving solvent. The solvent component may be composed of a good solvent and an application-improving solvent. It is preferable that the good solvent be contained at 50% by weight or more relative to a total amount of the varnish of the alignment film, and it is preferable that the application-improving solvent be contained at 10% by weight or more but not more than 40% by weight relative to a total amount of the varnish of the alignment film.

The good solvent includes, specifically, N, N-dimethylformamide, N, N-diethyl formamide, N, N-dimethylacetamide, N-methyl-2-pyrrolidone, N-methyl caprolactam, 2-pyrrolidone, N-ethyl pyrrolidone, N-vinylpyrrolidone, dimethyl sulfoxide, dimethyl sulfone, hexamethyl sulfoxide, γ-butyrolactone, 1,3-dimethylimidazolidinone, 3-methoxy-N, N-dimethylpropanamide, etc. Two or more of these may be used in combination.

The application-improving solvent refers to a solvent with lower surface tension than a good solvent. Specific examples of the application-improving solvent include ethyl cellosolve, ethyl cellosolve acetate, butyl cellosolve, butyl cellosolve acetate, ethyl carbitol, butyl carbitol, ethyl carbitol acetate, ethylene glycol, 1-methoxy-2-propanol, 1-ethoxy-2-propanol, 1-butoxy-2-propanol, 1-phenoxy-2-propanol, propylene glycol monoacetate, propylene glycol diacetate, propylene glycol-1-monomethyl propylene glycol-1-monoethyl ether-2-acetate, dipropylene glycol, 2-(2-ethoxypropoxy) propanol, methyl lactate, ethyl lactate, n-propyl lactate, n-butyl lactate, isoamyl lactate, etc. Two or more of these solvents may be used in combination.

The solid component may be contained at 0.5% by weight or more and 15% by weight or less relative to the total amount of the varnish. More preferably, the solid component may be contained at 2% by weight or more and 10% by weight or less relative to the total amount of the varnish.

The solid component may contain a coloring material in addition to the main component. However, the content ratio of the coloring material relative to a total amount of the solid component should preferably be less than 10 mol %. The lower the content of the coloring material relative to the total amount of the solid component, the higher the transmittance of the alignment film at a wavelength of 450 nm, thereby suppressing degradation of the alignment film.

The main component is a polyamide acid or polyamide acid ester having the unit structure shown in the following chemical formula (1).

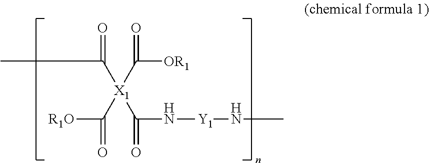

In chemical formula (1), X₁ is a tetravalent organic group. Y₁ is a divalent organic group containing no atoms with an electronegativity of 3 or higher, R₁ is a hydrogen atom or an alkyl group having 1 to 4 carbon atoms, and n is a positive integer.

From the perspective of the ease of progression of the imidization reaction upon heating of a polyamide acid or polyamide acid ester having the unit structure of chemical formula (1), R₁ is preferably a hydrogen atom, a methyl group, or an ethyl group, and a hydrogen atom or a methyl group is more preferable.

X₁ may be any tetravalent organic group, but is exemplified by structures represented by the following structural formulae (X-1) to (X-22). In the following structural formulae (X-1) to (X-22), the asterisk (*) indicates the bonding position with carbon (C) adjacent to X₁.

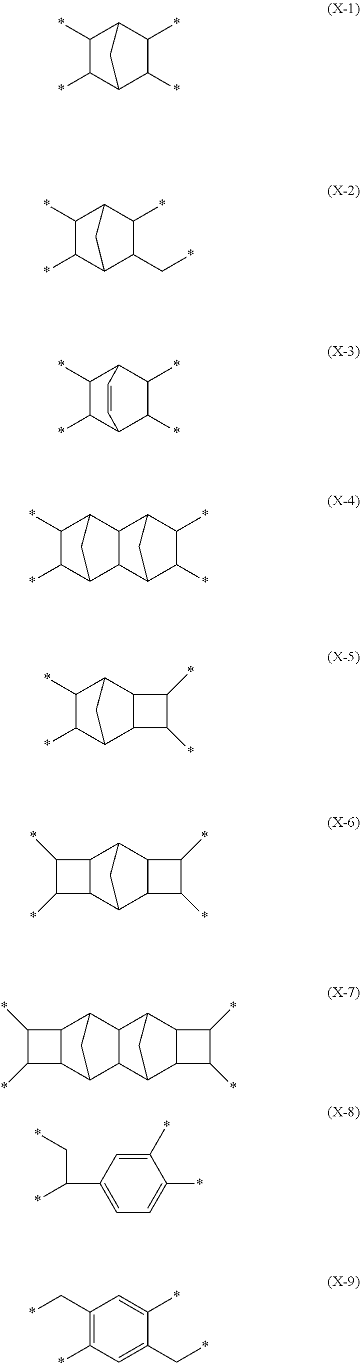

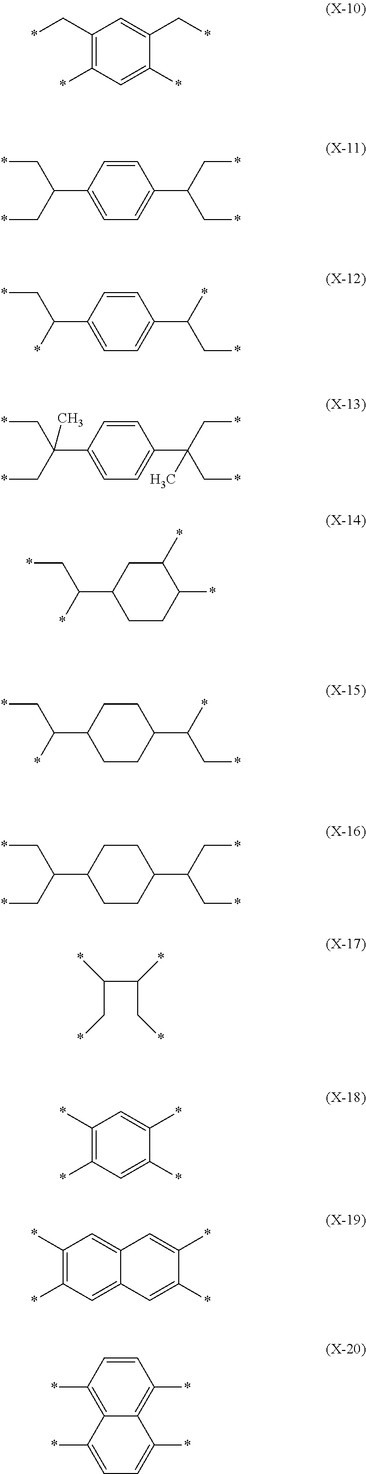

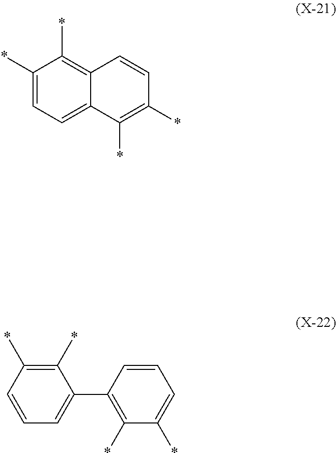 [SMILES: *c1ccc2c(*)c(*)ccc2c1* ; *c1cccc(-c2cccc(*)c2*)c1*]

In the structural formulae (X-1) to (X-22), from the perspective of ease of obtaining the compounds, the structure of X₁ is preferably that of the structural formulae (X-9), (X-17), (X-18), (X-19), and (X-20). Furthermore, in the structural formulae (X-1) to (X-22), from the perspective of obtaining an alignment film with rapid relaxation of residual charge accumulated by the DC voltage (Direct Current voltage) applied between electrodes sandwiching the liquid crystal layer, it is preferable to use a tetracarboxylic dianhydride having an aromatic ring structure for X₁, and the structural formulae (X-18) (X-19), and (X-20) are more preferable.

Furthermore, X₁ may also have a structure represented by the following structural formulae (X1-1) to (X1-4), in addition to the structures represented by the following structural formulae (X-1) to (X-22).

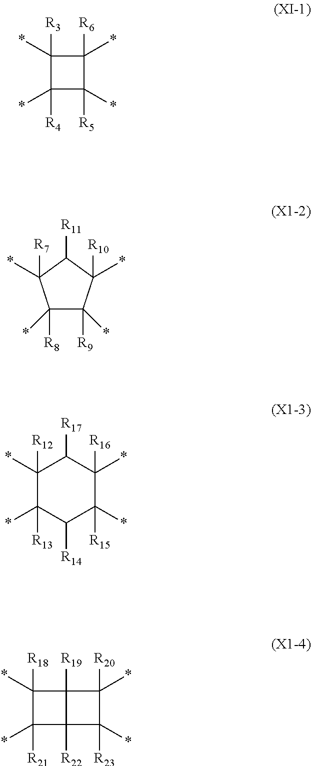

In the structural formulae (X1-1) to (X1-4), from the perspective of the alignment properties of the liquid crystal molecules in the alignment film, R₃ to R₂₃ are preferably a hydrogen atom, a halogen atom, a methyl group, or an ethyl group, and more preferably a hydrogen atom or a methyl group.

Specific structures corresponding to the structural formula (X1-1) include those represented by the following structural formulae (X1-11) to (X1-16). The asterisk (*) indicates the bonding position with carbon (C) adjacent to X₁.

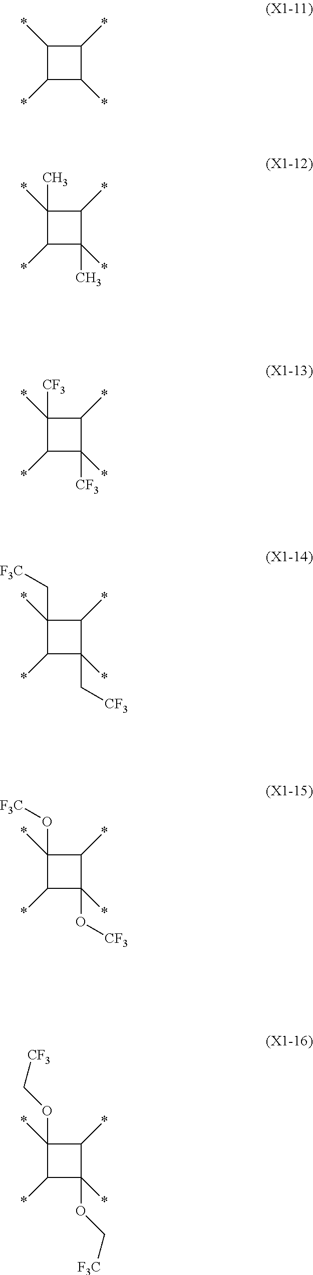

From the perspective of the orientation properties of liquid crystal molecules in the alignment film and the sensitivity of the photoreaction (reaction rate of the photoreaction), the following structural formulae (X1-11), (X1-12), and (X1-12a) are particularly preferable.

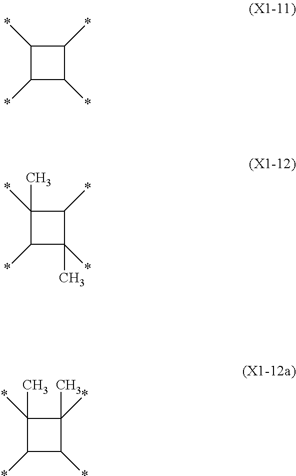

Y₁ may be any divalent organic group, but may be represented by the following chemical formula (2) or the following chemical formula (3).

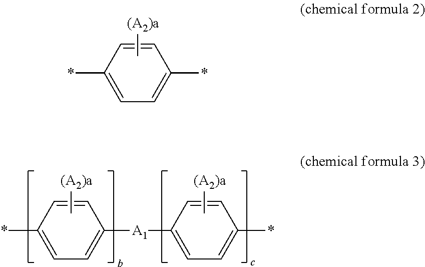

In chemical formula (2) and chemical formula (3), A₁ is a single bond, an ester bond, an amide bond, a thioester bond, or a divalent organic group having 2 to 20 carbon atoms, A₂ is a hydrogen atom, a halogen atom, a hydroxyl group, an amino group, a thiol group, a nitro group, a phosphate group, or a monovalent organic group having 1 to 20 carbon atoms, “a” is an integer of 1 to 4, when “a” is 2 or more, the structures of A₁ may be the same or different. “b” and “c” are each independently an integer from 1 to 2, and the asterisk (*) indicates the bonding position with nitrogen (N) adjacent to Y₁.

Y₁ is specifically represented by the following structural formulae (Y1-1) to (Y1-38), where the asterisk (*) indicates the bonding position with nitrogen (N) adjacent to Y₁.

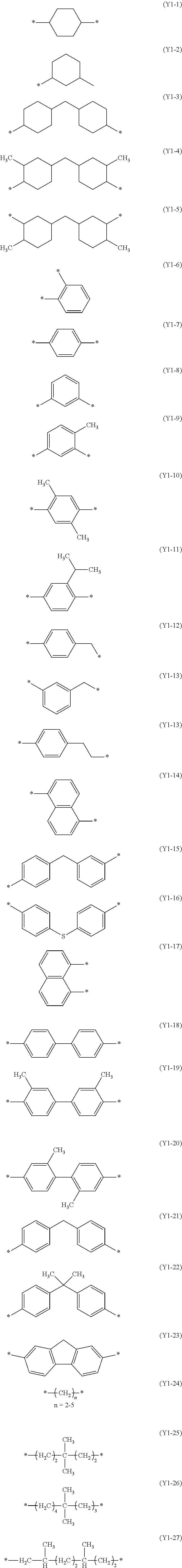

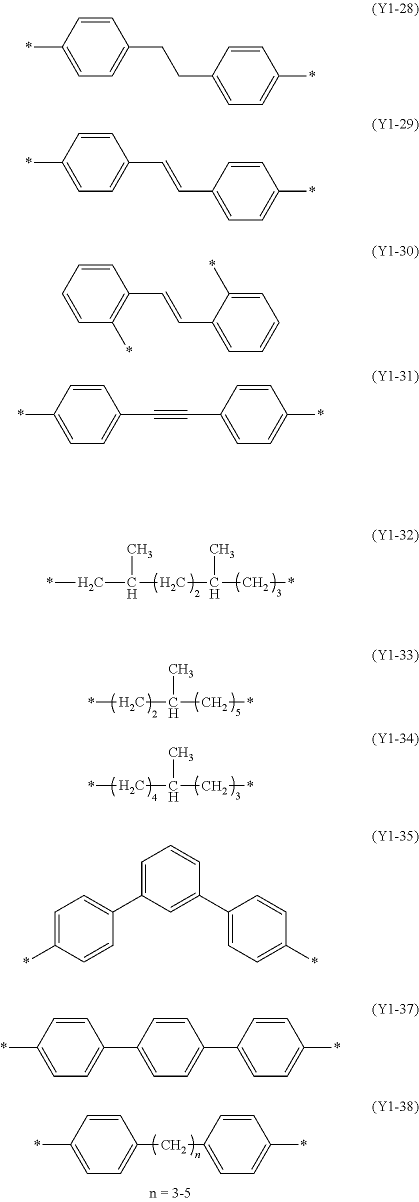

The coloring material is a polyamide acid or polyamide acid ester having the unit structure shown in the following chemical formula (4).

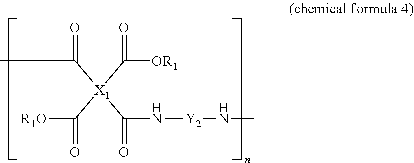

In chemical formula (4), X₁ is a tetravalent organic group, Y₂ is a divalent organic group containing an atom with an electronegativity of 3 or higher, R₁ is a hydrogen atom or an alkyl group having 1 to 4 carbon atoms, and n is a positive integer.

R₁ is the same as R₁ in chemical formula (1).

X₁ is specifically the same as X₁ in chemical formula (1).

Y₂ contains an atom with an electronegativity of 3 or higher. Y₂ is represented by the following chemical formula (5) or the following chemical formula (6).

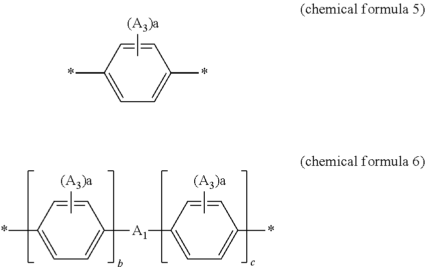

In chemical formula (5) and chemical formula (6), A₁ is a single bond, an ester bond, an amide bond, a thioester bond, or a divalent organic group having 2 to 20 carbon atoms, A₃ is an atom having an electronegativity of 3 or more, a hydrogen atom, a halogen atom, a hydroxyl group, an amino group, a thiol group, a nitro group, a phosphate group, or a monovalent organic group having 1 to 20 carbon atoms, “a” is an integer of 1 to 4 when “a” is 2 or more, A₃ may be the same or different, “b” and “c” are each independently an integer of 1 to 2 when A₃ is singular, A₃ is an atom having a electronegativity of 3 or more when A₃ is plural, and at least one is an atom having a electronegativity of 3 or more. The asterisk (*) indicates the bonding position with nitrogen (N) adjacent to Y₂.

Atoms with an electronegativity of 3 or higher in As are preferably selected from nitrogen (N), oxygen (O), fluorine (F), and chlorine (CI).

Structures containing atoms with an electronegativity of 3 or higher for Y₂ are specifically represented by the following structural formulae (Y2-1) to (Y2-42). In the following structural formulae (Y2-1) to (Y2-42), the asterisk (*) indicates the bonding position with nitrogen (N) adjacent to Y₂.

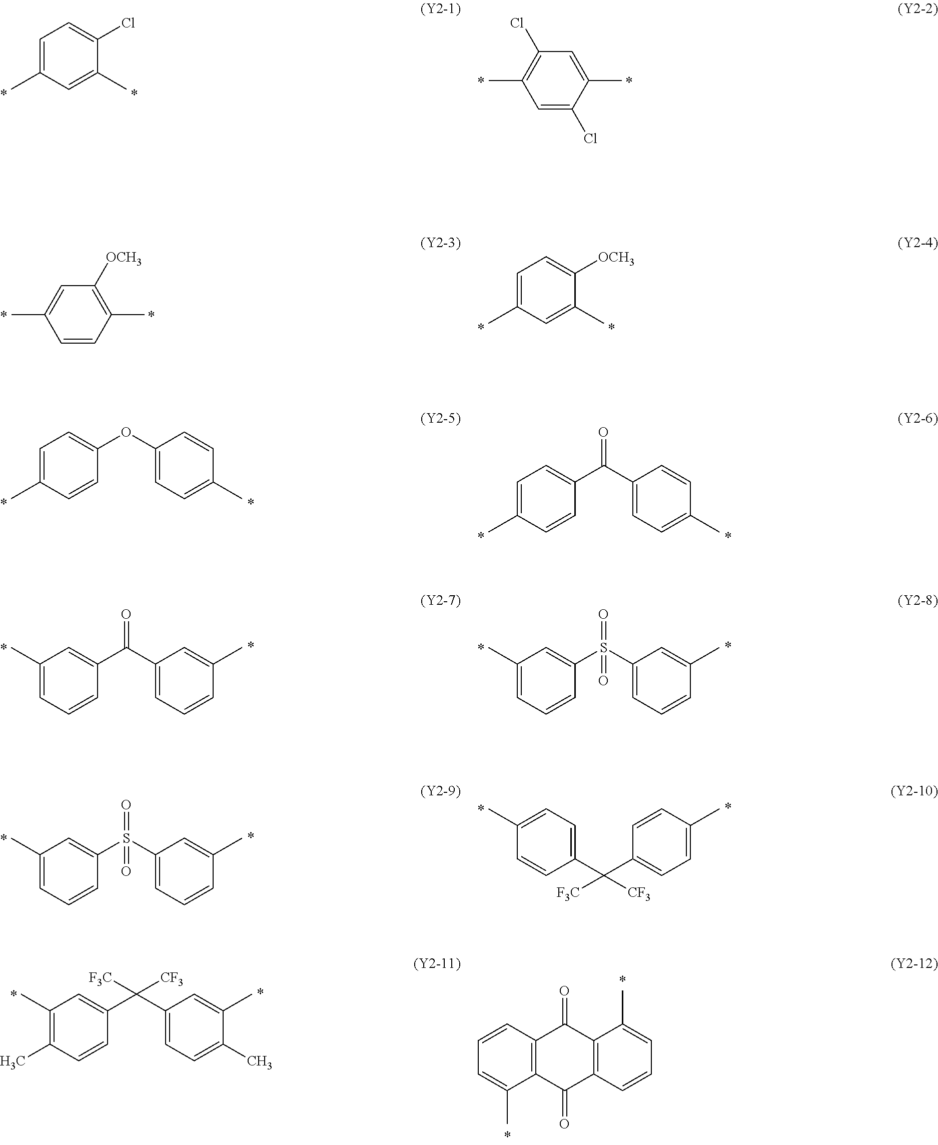

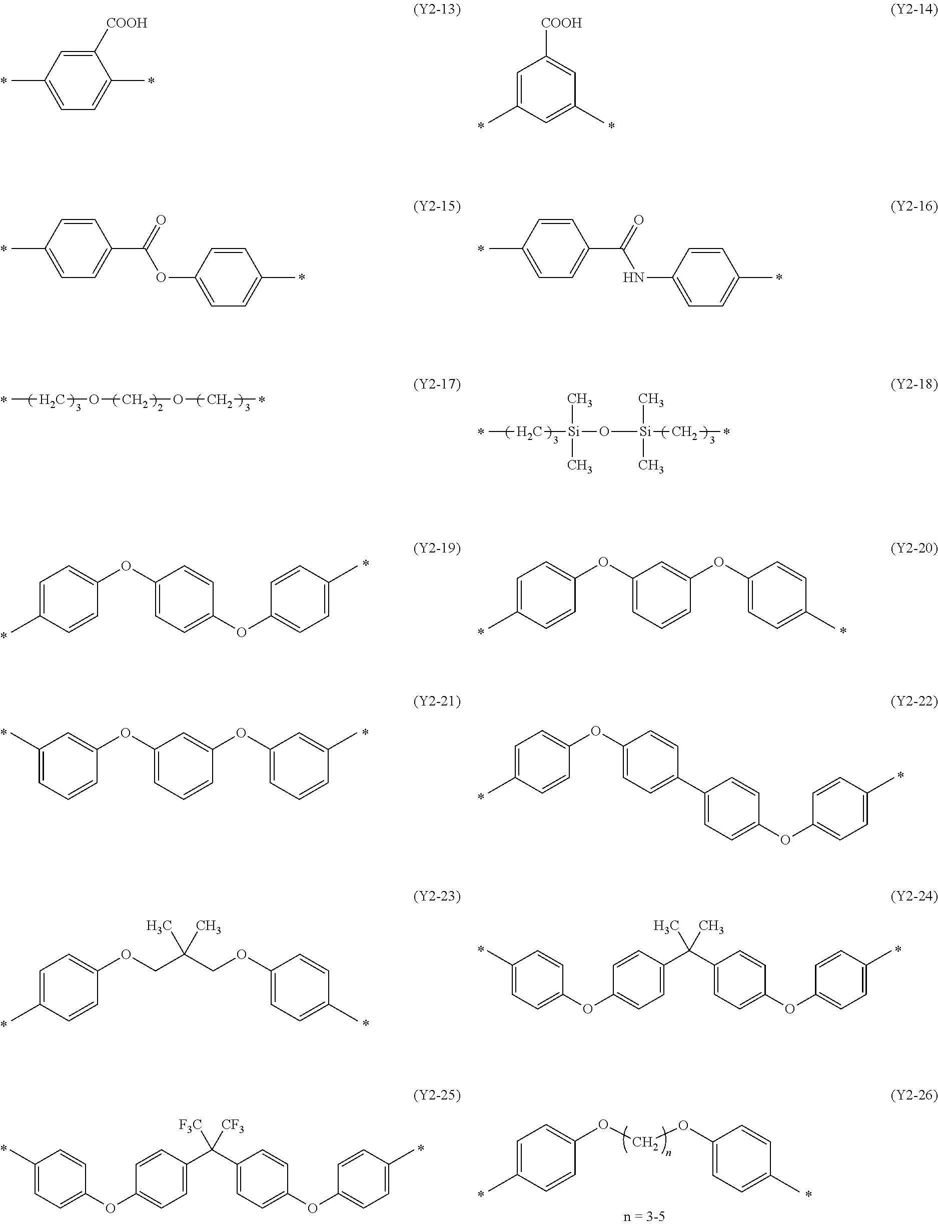

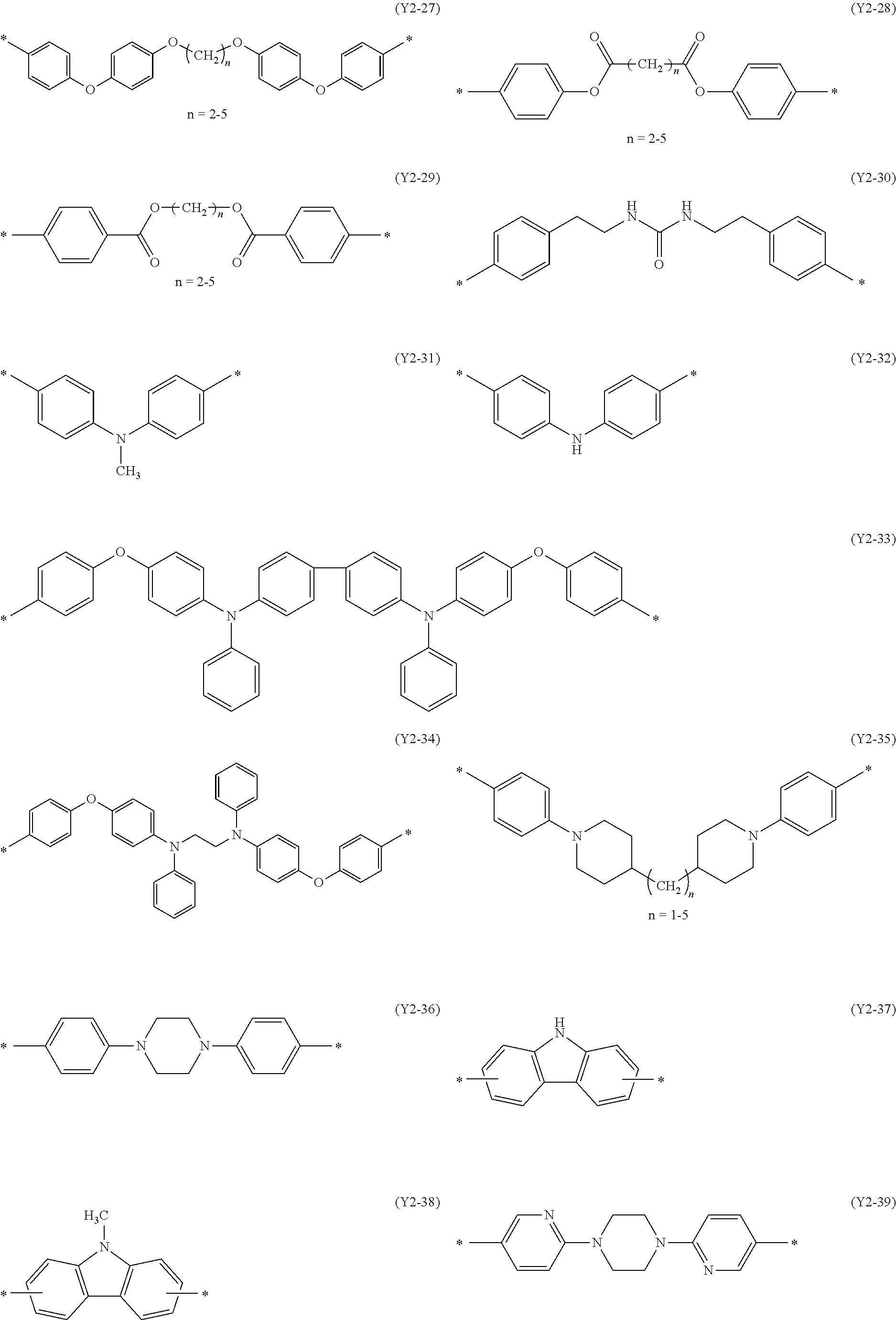

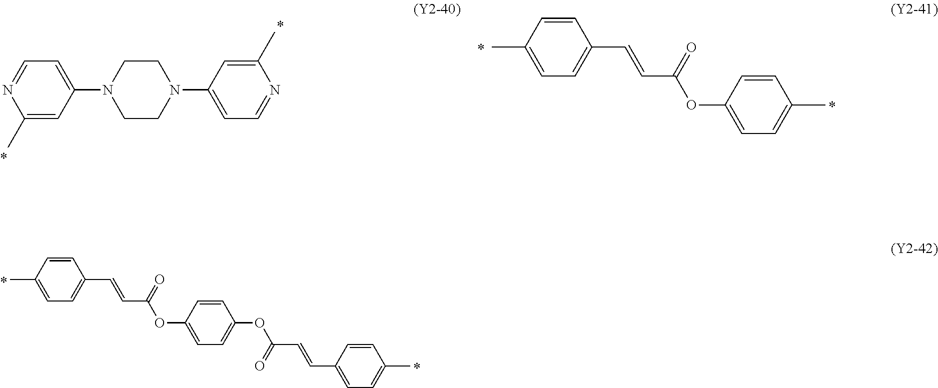

Next, the alignment film, which undergoes alignment processing (photoalignment processing) through irradiation with polarized ultraviolet light will be described.

The alignment film for light alignment processing can be formed using varnish, similar to the alignment film for rubbing processing. The solvent components in the varnish are the same as those in the solvent for the alignment film for rubbing processing.

The solid component in the varnish comprises a photodegradable component and a non-photodegradable component. The solid component in the varnish may be composed of a photodegradable component and a non-photodegradable component. The photodegradable components are orientation components that align liquid crystal molecules through photo-oxidation decomposition upon irradiation with polarized ultraviolet light. A content of the photodecomposition component in a solid component is 20% by mass or more and 50% by mass or less with respect to the total amount of the solid component. A content of the non-photodecomposition component in a solid component is 50% by mass or more and 80% by mass or less with respect to the total amount of the solid component.

The solid component may contain a coloring material. The content ratio of the coloring material in the photodegradable component relative to the total amount of the solid component is less than 10 mol %. The content ratio of the coloring material in the non-photodegradable component relative to the total amount of the solid component is less than 10 mol %. The lower the content of the coloring material relative to both photodegradable and non-photodegradable components, the higher the transmittance of the alignment film at a wavelength of 450 nm, thereby suppressing degradation of the alignment film.

The photodegradable component also exhibits high transmittance in the visible light region. The photodegradable component is a polyamide acid or a polyamide acid ester possessing the unit structure shown in the following chemical formula (7).

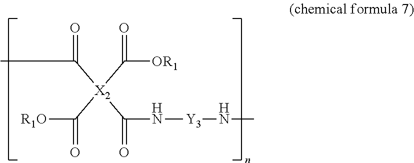

In chemical formula (7), X₂ is represented by the following structural formulae (X2-1) to (X2-4), Y₃ is a divalent organic group, and R₁ is a hydrogen atom or an alkyl group having 1 to 4 carbon atoms. “n” is a positive integer.

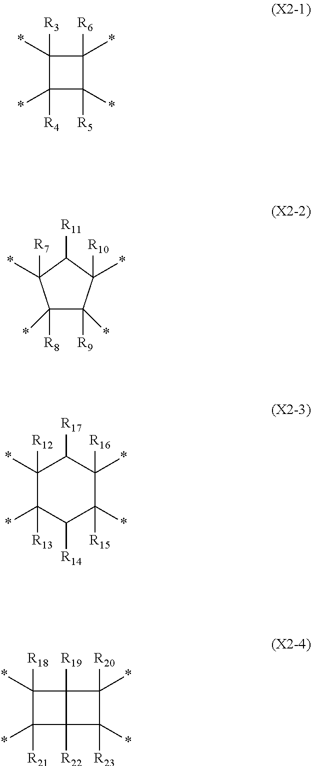

In the structural formulae (X2-1) to (X2-4), R₃ to R₂₃ each independently represent a hydrogen atom, a halogen atom, an alkyl group having 1 to 6 carbon atoms, an alkenyl group having 2 to 6 carbon atoms, an alkynyl group having 2 to 6 carbon atoms, a monovalent organic group having 1 to 6 carbon atoms containing a fluorine atom, or a phenyl group, and may be the same or different. In the structural formulae (X2-1) to (X2-4), the asterisk (*) denotes the bonding position with carbon (C) adjacent to X₂.

In structural formulae (X2-1) to (X2-4), from the perspective of the orientation of the liquid crystal molecules in the alignment film, R₃ to R₂₃ are preferably a hydrogen atom, a halogen atom, a methyl group, or an ethyl group, and more preferably a hydrogen atom or a methyl group.

Specific structures corresponding to the structural formula (X2-1) include those represented by the following structural formulae (X2-11) to (X2-16). The asterisk (*) indicates the bonding position with carbon (C) adjacent the X₂.

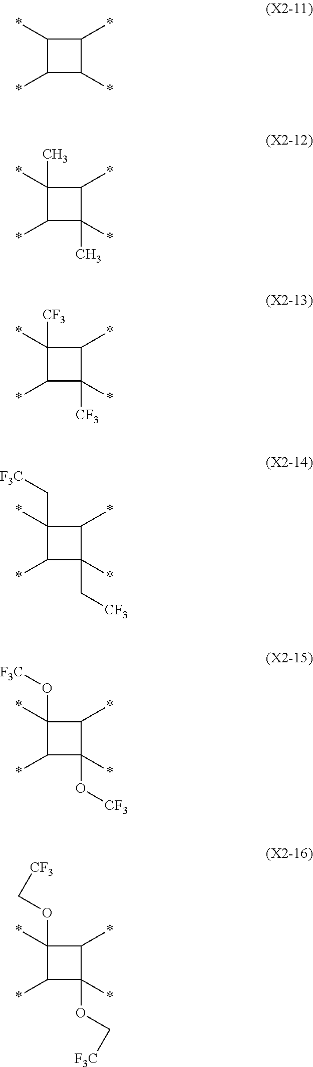

From the perspective of the orientation properties of liquid crystal molecules in the alignment film and the sensitivity of photoreactions, the following structural formulae (X2-11), (X2-12), and (X2-12a) are particularly preferred.

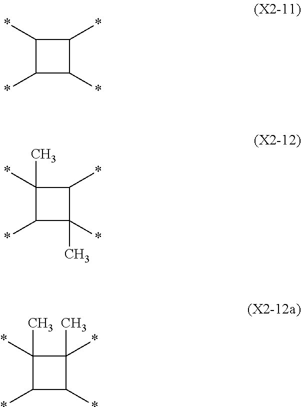

In chemical formula (7), Y₃ may be represented by chemical formula (8) or chemical formula (9) below.

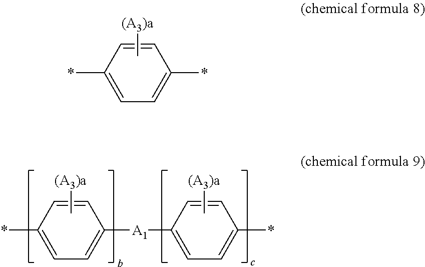

In chemical formula (8) and chemical formula (9), A₁ is a single bond, an ester bond, an amide bond, a thioester bond, or a divalent organic group having 2 to 20 carbon atoms, A₃ is an atom having an electronegativity of 3 or more, a hydrogen atom, a halogen atom, a hydroxyl group, an amino group, a thiol group, a nitro group, a phosphate group, or a monovalent organic group having 1 to 20 carbon atoms, “a” is an integer of 1 to 4, and “b” and “c” are each independently an integer of 1 to 2. The asterisk (*) indicates the bonding position with nitrogen (N) adjacent to Y₃.

Y₃ may be represented, for example, by the above structural formulae (Y1-1) to (Y1-38) and the above structural formulae (Y2-1) to (Y2-42).

R₁ is preferably a hydrogen atom, methyl group, or ethyl group, and more preferably a hydrogen atom or methyl group, from the perspective of the ease of progression of the imidization reaction upon heating of polyamide acids or polyamide acid esters having the unit structure of chemical formula (7).

The coloring material contained in the photodegradable component is a polyamide acid or polyamide acid ester having the unit structure shown in the following chemical formula (10).

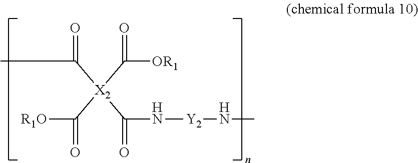

In chemical formula (10), X₂ is the same as X₂ in the aforementioned chemical formula (7), and Y₂ and R₁ are the same as Y₂ and R₁ in the aforementioned chemical formula (4).

The non-photodegradable component is a polyamide acid or polyamide acid ester having the unit structure shown in the following chemical formula (11).

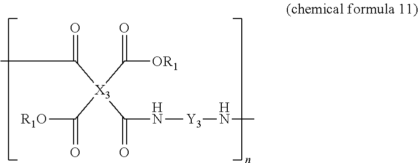

In chemical formula (11), X₃ is represented by the following structural formulae (X3-1) to (X3-22), and Y₃ and R₁ are the same as Y₃ and R₁ in chemical formula (7). n is a positive integer. In the following 5 structural formulae (X3-1) to (X3-22), the asterisk (*) indicates the bonding position with carbon (C) adjacent to X₃.

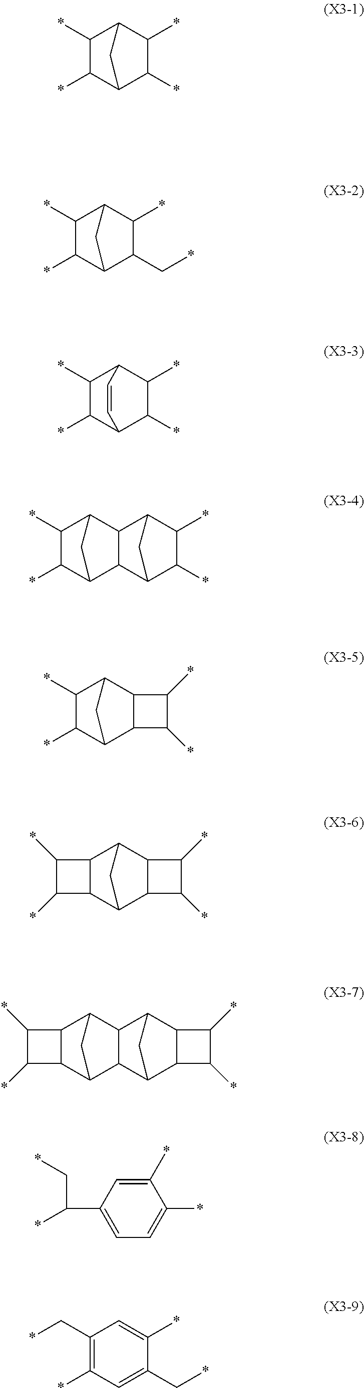

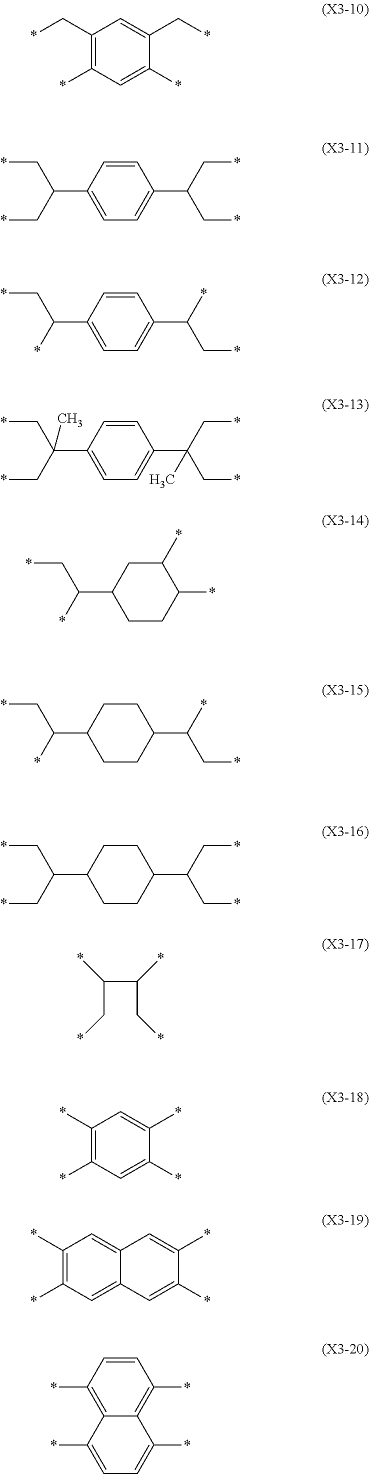

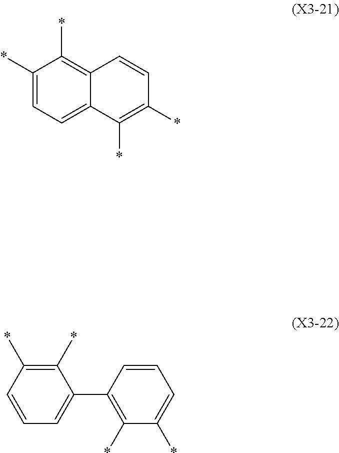 [SMILES: *c1ccc2c(*)c(*)ccc2c1* ; *c1cccc(-c2cccc(*)c2*)c1*]

In the structural formulae (X3-1) to (X3-22), from the perspective of ease of obtaining the compounds, the structures of X₃ in the structural formulae (X3-9), (X3-17), (X3-18), (X3-19), and (X3-20) are preferred. Furthermore, in the structural formulae (X3-1) to (X3-22), from the perspective of obtaining an alignment film with rapid relaxation of residual charge accumulated by the DC voltage applied between electrodes sandwiching the liquid crystal layer, it is preferable to use a tetracarboxylic dianhydride having an aromatic ring structure for X₃, and the structural formulae (X3-18), (X3-19), and (X3-20) are more preferable.

The coloring material contained in the non-photodegradable component is a polyamide acid or polyamide acid ester having the unit structure of the above chemical formula (8) or the above chemical formula (9).

By using the alignment film described above, the alignment film of the present embodiment suppresses degradation and enables control of the alignment direction of liquid crystal molecules.

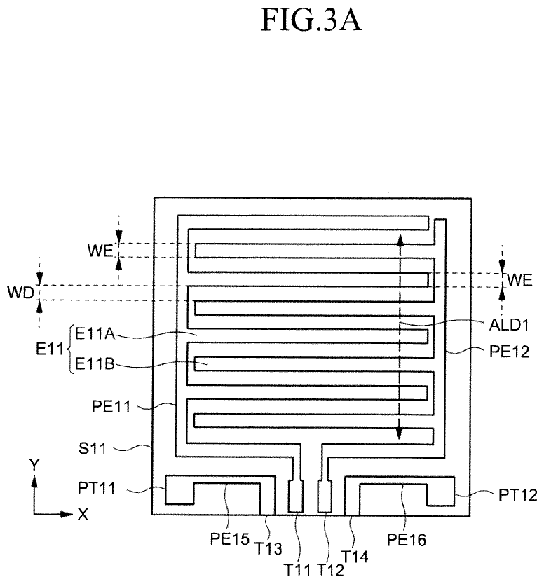

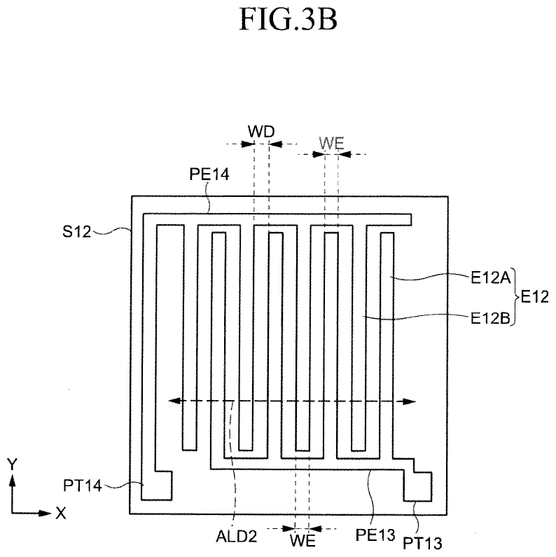

FIG. 3A shows a plan view of the first substrate S11, and FIG. 3B shows a plan view of the second substrate S12. As shown in FIG. 3A, the first electrode E11 has a structure in which a plurality of first strip electrodes E11A and a plurality of second strip electrodes E11B are arranged alternately. The longitudinal directions of the plurality of first strip electrodes E11A and the plurality of second strip electrodes E11B extend in the X-axis direction. In contrast, the alignment direction of the first alignment film AL11 (not shown) extends in the Y-axis direction. That is, the direction in which the longitudinal directions of the plurality of first strip electrodes E11A and the plurality of second strip electrodes E11B extend intersects (is orthogonal to) the alignment direction. Furthermore, as shown in FIG. 3B, the second electrode E12 has a structure where a plurality of third strip electrodes E12A and a plurality of fourth strip electrodes E12B are arranged alternately. The longitudinal directions of the plurality of third strip electrodes E12A and the plurality of fourth strip electrodes E12B extend in the Y-axis direction. In contrast, the alignment direction of the second alignment film AL12 (not shown) extends along the X-axis direction. That is, the direction in which the longitudinal directions of the plurality of third strip electrodes E12A and the plurality of fourth strip electrodes E12B extend intersects (is orthogonal to) the alignment direction.

As shown in FIG. 3A, a plurality of first strip electrodes E11A are each connected to a first power supply line PE11, and a plurality of second strip electrodes E11B are each connected to a second power supply line PE12. The first power supply line PE11 is connected to the first connection terminal T11, and the second power supply line PE12 is connected to the second connection terminal T12. The first connection terminal T11 and the second connection terminal T12 are provided at the end of the first substrate S11. A third connection terminal T13 is provided adjacent to the first connection terminal T11 on the first substrate S11, and a fourth connection terminal T14 is provided adjacent to the second connection terminal T12. The third connection terminal T13 is connected to a fifth power supply line PE15. The fifth power supply line PE15 is connected to the first power supply terminal PT11 provided on the first substrate S11. The fourth connection terminal T14 is connected to the sixth power supply line PE16. The sixth power supply line PE16 is connected to the second power supply terminal PT12 provided on the first substrate S11.

The plurality of first strip electrodes E11A are supplied with the same voltage via a first power supply line PE11. A plurality of second strip electrodes E11B are supplied with the same voltage via a second power supply line PE12. When different voltages are applied to the first connection terminal T11 and the second connection terminal T12, a potential difference arises between the plurality of first strip electrodes E11A and the plurality of second strip electrodes E11B, generating an electric field. Consequently, an electric field in the lateral direction (Y-axis direction) is generated by the plurality of first strip electrodes E11A and the plurality of second strip electrodes E11B.

As shown in FIG. 3B, a plurality of third strip electrodes E12A are each connected to a third power supply line PE13, and a plurality of fourth strip electrodes E12B are each connected to a fourth power supply line PE14. The third power supply line PE13 is connected to the third power supply terminal PT13, and the fourth power supply line PE14 is connected to the fourth power supply terminal PT14. The third power supply terminal PT13 is positioned corresponding to the first power supply terminal PT11 on the first substrate S11, and the fourth power supply terminal PT14 is positioned corresponding to the second power supply terminal PT12 on the first substrate S11. The third power supply terminal PT13 is electrically connected to the first power supply terminal PT11, and the fourth power supply terminal PT14 is electrically connected to the second power supply terminal PT12. Conductive paste is used for the electrical connection between these power supply terminals. For example, silver paste is used as the conductive paste.

When different voltages are applied to the third connection terminal T13 and the fourth connection terminal T14, a potential difference arises between the plurality of third strip electrodes E12A and the plurality of fourth strip electrodes E12B, generating an electric field. Consequently, an electric field in the lateral direction (X-axis direction) is generated by the plurality of third strip electrodes E12A and the plurality of fourth strip electrodes E12B.

The first substrate S11 and the second substrate S12 are substrates having light transmittance, such as glass substrates or resin substrates. The first electrode E11 and the second electrode E12 are transparent electrodes formed from materials such as indium tin oxide (ITO) or indium zinc oxide (IZO). The power supply lines (first power supply line PE11, second power supply line PE12, third power supply line PE13, fourth power supply line PE14) and the connection terminals (first connection terminal T11, second connection terminal T12, third connection terminal T13, fourth connection terminal T14) are formed from metal materials such as aluminum, titanium, molybdenum, tungsten, or other metallic materials. The power supply lines (first power supply line PE11, second power supply line PE12, third power supply line PE13, fourth power supply line PE14) may also be formed from the same transparent conductive film as the first electrode E11 and second electrode E12. Of course, a configuration where either one or both of the first electrode E11 and the second electrode E12 are formed from a metal material or a transparent conductive film overlaid with a metal material may also be adopted.

The width WE of the first strip electrode E11A, the second strip electrode E11B, the third strip electrode E12A, and the fourth strip electrode E12B is preferably 5 μm or more. By providing each strip electrode with a width of 5 μm or more, a reduction of resistance loss is enabled even when each strip electrode is formed with a transparent conductive film as described above, and allows formation of a uniform transverse electric field within the plane. Furthermore, for the same reason, it is also desirable that the widths of the first power supply line PE11, the second power supply line PE12, the third power supply line PE13, and the fourth power supply line PE14 are similarly 5 μm or more.

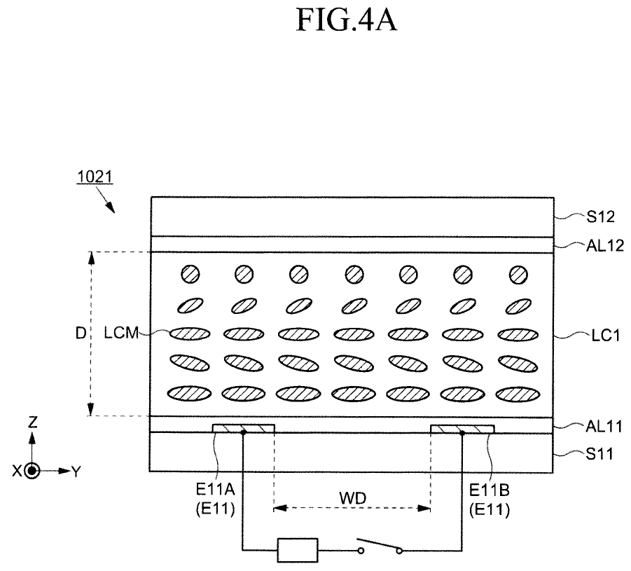

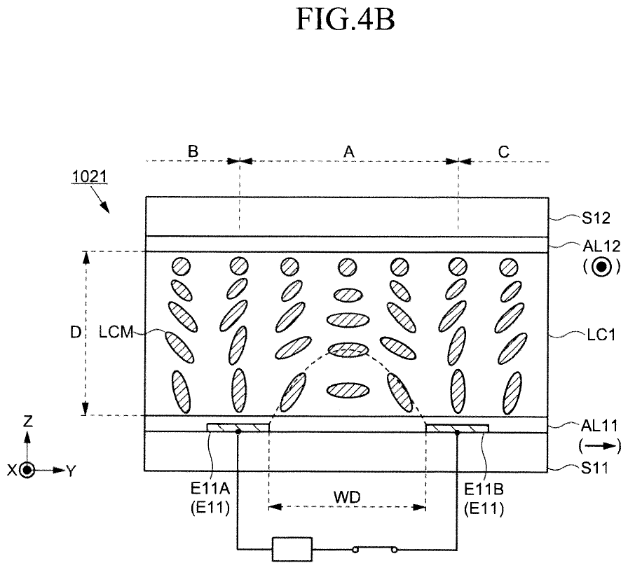

FIG. 4A and FIG. 4B are diagrams illustrating the operation of the first liquid crystal panel 1021, and show the structure of the first liquid crystal panel 1021 shown in FIG. 2 as viewed from the XA side. FIG. 4A shows the state where no voltage is applied to the first electrode E11 (comprising the first strip electrode E11A and the second strip electrode E11B). FIG. 4B shows the state where voltage is applied to the first electrode E11, generating a transverse electric field between the first strip electrode E11A and the second strip electrode E11B.

The first strip electrode E11A and the second strip electrode E11B are arranged with the longitudinal direction of the strip pattern extending along the X-axis and with an interval WD between them. Here, comparing the thickness D of the first liquid crystal layer LC1 with the electrode spacing WD of the first electrode E11, the thickness D of the first liquid crystal layer LC1 is equal to or greater than the electrode spacing WD (D≥WD). For example, the thickness D of the first liquid crystal layer LC1 is at least twice as large as the electrode spacing WD of the first electrode E11. For example, when the thickness D of the first liquid crystal layer LC1 is 10 μm, the electrode spacing WD can be 5 μm, and when the thickness D of the first liquid crystal layer LC1 is 50 μm, the electrode spacing WD can be 10 μm.

The alignment direction of the first alignment film AL11 extends along the Y-axis, and the alignment direction of the second alignment film AL12 extends along the X-axis. When no electric field is applied to the first liquid crystal layer LC1 (FIG. 4A), the long axes of the liquid crystal molecules LCM align in a state twisted 90 degrees from the side of the first substrate S11 toward the side of the second substrate S12. At this time, the first liquid crystal layer LC1 possesses a uniform refractive index distribution. When light is incident onto the first liquid crystal panel 1021, the incident light is optically rotated due to the twist of the liquid crystal molecules LCM. At this time, the incident light transmits through the first liquid crystal layer LC1 without refraction (or scattering) while undergoing optical rotation.

On the other hand, when a voltage is applied to the first electrode E11, a transverse electric field is generated between the first strip electrode E11A and the second strip electrode E11B, and the long axes of the liquid crystal molecules LCM align parallel to the electric field (when the liquid crystal exhibits positive dielectric anisotropy). As a result, as shown in FIG. 4B, regions are formed where the liquid crystal molecules LCM rise above the first strip electrode E11A and the second strip electrode E11B, and regions where the molecules are oriented obliquely along the electric field distribution between the first strip electrode E11A and the second strip electrode E11B. At this time, if the thickness D of the first liquid crystal layer LC1 is sufficiently large (10 μm or more), i.e., if the thickness D of the first liquid crystal layer LC1 is sufficiently large, the influence of the electric field formed by the first electrode E11 does not extend to the side of the second substrate S12, and the orientation state of the liquid crystal molecules LCM changes only on the side of the first substrate S11. That is, the liquid crystal molecules LCM on the side of the second substrate S12 are not affected by the electric field and maintain a state where their orientation does not change.

As shown in FIG. 4B, when a transverse electric field is generated between the first strip electrode E11A and the second strip electrode E11B, the liquid crystal molecules LCM align in a convex arc shape with their long axes oriented along the direction of the electric field. The liquid crystal, possessing refractive index anisotropy, exhibits a corresponding arc-shaped change in its refractive index distribution due to this change in the alignment state of the liquid crystal molecules LCM. When light is incident from the side of the first substrate S11 in this state, the polarization component parallel to the Y-axis direction diffuses radially due to this refractive index distribution. Meanwhile, the polarization component parallel to the X-axis is unaffected by the refractive index distribution and enters the first liquid crystal layer LC1 without diffusion. Thus, by aligning the liquid crystal molecules LCM in a predetermined direction and changing their alignment state using a transverse electric field, specific polarization components within the incident light can be diffused (broadening the luminance distribution).

Moreover, while the effects of the first electrode E11 on the liquid crystal molecules LCM and the incident light are explained in FIGS. 4A and 4B, the same applies to the effects of the second electrode E12 on the first liquid crystal layer LC1. Specifically, on the side of the second substrate S12, generating a transverse electric field via the second electrode E12 enables the diffusion (widening of the luminance distribution) of the polarization component parallel to the X-axis.

As described with reference to FIGS. 4A and 4B, the first liquid crystal panel 1021 can diffuse incident light in a predetermined direction. Therefore, using the first liquid crystal panel 1021 makes it possible to control the light distribution state of light emitted from the light source. However, when strong light is irradiated onto the alignment films (the first alignment film AL11, the second alignment film AL12), the alignment films may degrade due to the light's influence. In particular, the effect can be particularly significant for alignment films formed from organic materials such as polyimide-based films. Although the alignment film in liquid crystal displays is also exposed to backlight illumination, the light intensity is lower compared to lighting sources, and short-wavelength light with high-energy is absorbed by the polarizer, making alignment film degradation a non-issue. Conversely, when used for lighting applications like the liquid crystal light control element 102 of the present embodiment, where strong light from the light source is incident, the alignment film is in a situation prone to degradation.

When the alignment film deteriorates, the problem arises that the alignment control force on the liquid crystal molecules (LCMs) decreases. When the alignment control force decreases, the direction of twist of the liquid crystal molecules (LCMs) becomes undefined. Consequently, when the voltage is turned off and the electric field is removed, a phenomenon occurs where the direction of twist reverses (hereinafter also referred to as “reverse twist”), leading to the destabilization of the alignment of the liquid crystal molecules (LCMs).

As shown in the present embodiment, employing an alignment film with a transmittance of 98% or higher at a wavelength of 450 nm can suppress the occurrence of reverse twist.

### 3. Operation of the Liquid Crystal Panel

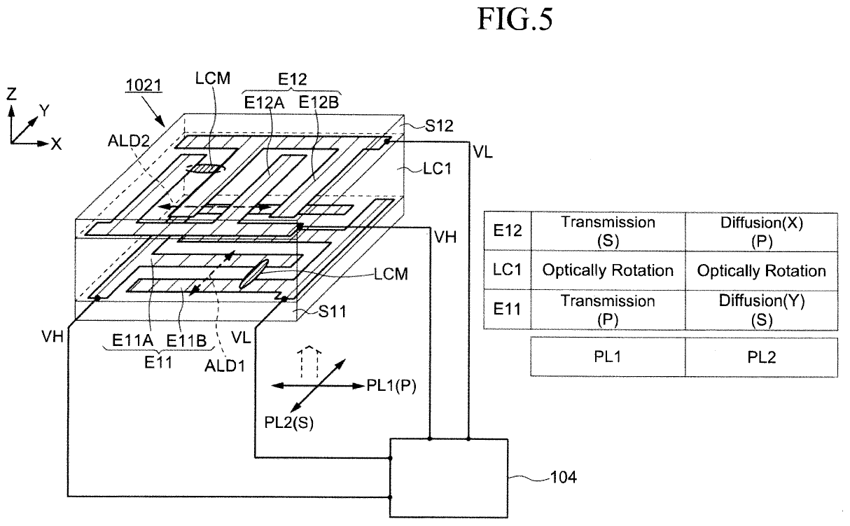

FIG. 5 shows the first liquid crystal panel 1021, illustrating a state where the first strip electrode E11A and second strip electrode E11B of the first electrode E11 extend in the X-axis direction, and the third strip electrode E12A and fourth strip electrode E12B of the second electrode E12 extend in the Y-axis direction. The alignment direction of the first alignment film AL1 is parallel to the Y-axis, and the alignment direction of the second alignment film AL2 is parallel to the X-axis. Consequently, the long axes of the liquid crystal molecules (LCMs) on the side of the first substrate S11 face the Y-axis direction, and the long axes of the liquid crystal molecules (LCMs) on the side of the second substrate S12 face the X-axis direction.

Furthermore, FIG. 5 shows a state where a high-level voltage VH is applied to the first strip electrode E11A and a low-level voltage VL (VH>VL) is applied to the second strip electrode E11B from the control circuit 104, and a high-level voltage VH is applied to the third strip electrode E12A while a low-level voltage VL (VH>VL) is applied to the fourth strip electrode E12B.

Light emitted from the light source possesses a first polarization component PL1 and a second polarization component PL2, and is incident onto the first liquid crystal panel 1021 from the side of the first substrate S11. Here, the first polarization component PL1 corresponds to a P-wave (having an amplitude in the X-axis direction), and the second polarization component PL2 corresponds to an S-wave (having an amplitude in the Y-axis direction). As shown in the table inserted in FIG. 5, the light incident on the first liquid crystal panel 1021 undergoes optical effects such as transmission, optical rotation, and diffusion within the first liquid crystal layer LC1.

Here, “transmission” as shown in the table refers to the passage of light without changing the polarization axis of a specified polarization component or altering the light distribution state. “Diffusion (Y)” indicates that the polarization component diffuses in a direction parallel to the Y-axis. Although not shown in FIG. 5, “Diffusion (X)” indicates that the polarization component diffuses in a direction parallel to the X-axis.

The first polarization component PL1 is a P-wave. Therefore, at the side of the first electrode E11, its polarization direction intersects the long axis direction of the liquid crystal molecules LCM and passes through without being affected by the arc-shaped refractive index distribution formed by the alignment of the liquid crystal molecules LCM. The first polarization component PL1 undergoes a 90-degree optical rotation as it passes through the first liquid crystal layer LC1 from the side of the first substrate S11 to the side of the second substrate S12, transitioning to an S-wave state. The first polarized component PL1, having transitioned to the S-wave state, passes through the side of the second electrode E12 without being affected by the arc-shaped refractive index distribution formed by the alignment of the liquid crystal molecules LCM, as its polarization direction intersects with the long axis direction of the liquid crystal molecules LCM.

On the other hand, the second polarization component PL2 is an S-wave. Since its polarization direction is parallel to the long axis of the liquid crystal molecules LCM at the side of the first electrode E11, it diffuses in the Y-axis direction due to the influence of the arc-shaped refractive index distribution formed by the alignment of the liquid crystal molecules LCM. The second polarization component PL2 undergoes a 90-degree optical rotation as it propagates from the side of the first substrate S11 to the side of the second substrate S12 through the first liquid crystal layer LC1, transitioning to a P-wave state. The second polarization component PL2, having transitioned to the P-wave state, diffuses in the X-axis direction at the side of the second electrode E12. This occurs because the polarization direction becomes parallel to the long axis direction of the liquid crystal molecules LCM, causing it to be affected by the arc-shaped refractive index distribution formed by the alignment of the liquid crystal molecules LCM.

Thus, when light enters the first liquid crystal panel 1021 from the side of the first substrate S11, the first polarization component PL1 (P-wave) is not diffused, is optically rotated in the first liquid crystal layer LC1, and is emitted as an S-wave. The second polarization component PL2 (S-wave) is diffused once in the Y-axis direction and once in the X-axis direction, is optically rotated in the first liquid crystal layer LC1, and is emitted as a P-wave.

FIG. 5 shows an example where the second polarization component PL2 (S-wave) is diffused in the Y-axis and X-axis directions by the first liquid crystal panel 1021. However, by combining multiple liquid crystal panels, it is also possible to diffuse the first polarization component PL1 (P-wave).

### 4. Operation of the Liquid Crystal Light Control Element

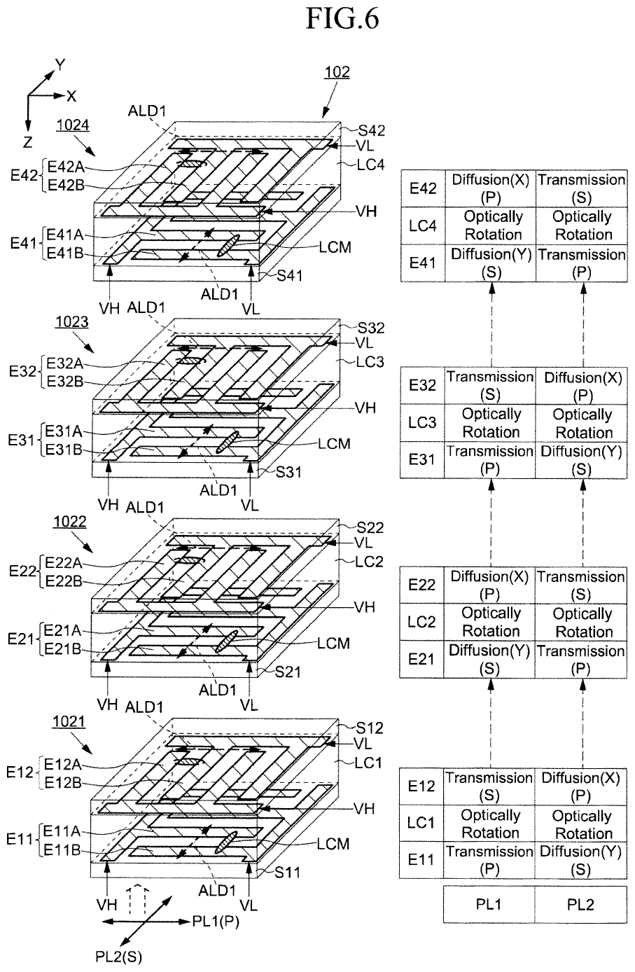

FIG. 6 shows an example of the operation of the liquid crystal light control element 102. As described with reference to FIG. 1, the liquid crystal light control element 102 comprises four liquid crystal panels (first liquid crystal panel 1021, second liquid crystal panel 1022, third liquid crystal panel 1023, fourth liquid crystal panel 1024) having a configuration similar to that of the first liquid crystal panel 1021. For illustrative purposes, FIG. 6 shows the liquid crystal panels arranged separately. However, the actual liquid crystal light control element 102 has a structure where each liquid crystal panel is bonded together using a transparent adhesive.

The second liquid crystal panel 1022, the third liquid crystal panel 1023, and the fourth liquid crystal panel 1024 have the same configuration as the first liquid crystal panel 1021 shown in FIG. 5. Specifically, the second liquid crystal panel 1022 comprises a first substrate S21, a second substrate S22, a first electrode E21, a second electrode E22, and a second liquid crystal layer LC2. The third liquid crystal panel 1023 comprises a first substrate S31, a second substrate S32, a first electrode E31, a second electrode E32, and a third liquid crystal layer LC3. The fourth liquid crystal panel 1024 comprises a first substrate S41, a second substrate S42, a first electrode E41, a second electrode E42, and a fourth liquid crystal layer LC4. Note that for simplicity, the alignment films present in each liquid crystal panel are omitted in the drawings of FIG. 6.

The first electrodes E11, E21, E31, E41 comprise the first strip electrodes E11A, E21A, E31A, E41A and the second strip electrodes E11B, E21B, E31B, E41B. These strip electrodes extend in the X-axis direction. The second electrodes E12, E22, E32, E42 comprise third strip electrodes E12A, E22A, E32A, E42A and fourth strip electrodes E12B, E22B, E32B, E42B, with these strip electrodes extending in the Y-axis direction.

Each liquid crystal panel is supplied with control signals consisting of a low-level voltage VL, a high-level voltage VH, and a constant voltage CV. The low-level voltage VL is, for example, 0V or −15V, and the high-level voltage VH is, for example, 30V (relative to VL=0V) or 15V (relative to VL=−15V). The constant voltage CV is, for example, a voltage signal at an intermediate voltage between VL and VH or 0V (ground).

FIG. 6 shows a state where a high-level voltage VH and a low-level voltage VL are applied as control signals to the first electrode E11 and second electrode E12 of the first liquid crystal panel 1021, the first electrode E21 and second electrode E22 of the second liquid crystal panel 1022, the first electrode E31 and second electrode E32 of the third liquid crystal panel 1023, and the first electrode E41 and second electrode E42 of the fourth liquid crystal panel 1024. That is, the liquid crystal molecules are oriented by the transverse electric field on the side of the first substrate S11, S21, S31, S41 and the side of the second substrate S12, S22, S32, S42 of each liquid crystal panel.

FIG. 6 shows that light emitted from the light source enters from the side of the first liquid crystal panel 1021 and exits from the side of the fourth liquid crystal panel 1024. The light emitted from the light source contains a first polarization component PL1 (P-wave) and a second polarization component PL2 (S-wave). The table inserted in FIG. 6 shows how diffusion, optical rotation, and transmission change in each liquid crystal panel.

Among the light incident on the first liquid crystal panel 1021, the first polarization component PL1 (P-wave) transmits through the side of the first electrode E11, undergoes optical rotation in the first liquid crystal layer LC1 and transitions to an S-wave, transmits through the side of the second electrode E12, and is emitted. The second polarization component PL2 (S-wave) diffuses in the Y-axis direction on the first electrode E11 side, undergoes optical rotation in the first liquid crystal layer LC1 and transitions to a P-wave, then diffuses in the X-axis direction on the side of the second electrode E12 and is emitted. Thus, the polarization state of both the first polarization component PL1 and the second polarization component PL2 changes as they pass through the first liquid crystal panel 1021, and the second polarization component PL2 is diffused in the Y-axis and X-axis directions before being emitted.

A similar phenomenon occurs in the second liquid crystal panel 1022, the third liquid crystal panel 1023, and the fourth liquid crystal panel 1024. Specifically, the first polarization component PL1 and the second polarization component PL2 incident on the second liquid crystal panel 1022 undergo a change in their polarization state as they pass through the second liquid crystal panel 1022, and the first polarization component PL1 is diffused in the Y-axis and X-axis directions and emitted. The first polarization component PL1 and the second polarization component PL2 incident on the third liquid crystal panel 1023 undergo a change in their polarization state as they pass through the third liquid crystal panel 1023, and the second polarization component PL2 is diffused in the Y-axis direction and the X-axis direction and emitted. Then, the first polarized component PL1 and the second polarized component PL2 incident on the fourth liquid crystal panel 1024 undergo a change in their polarization state as they pass through the fourth liquid crystal panel 1024, and the first polarized component PL1 is diffused in the Y-axis direction and the X-axis direction and emitted.

In this manner, the first polarization component (P-wave) of light emitted from the light source is diffused twice in the Y-axis direction and twice in the X-axis direction as it passes through the first liquid crystal panel 1021 to the fourth liquid crystal panel 1024. The second polarization component (S-wave) is also diffused twice in the Y-axis direction and twice in the X-axis direction as it passes from the first liquid crystal panel 1021 to the fourth liquid crystal panel 1024. That is, since the first polarization component PL1 and the second polarization component PL2 are uniformly diffused in both the X-axis and Y-axis directions, a square-shaped light distribution pattern can be formed.

The voltage application conditions shown in FIG. 6 are one example and various alignment patterns can be formed by combining different voltage application conditions. For example, applying a voltage application pattern that diffuses only in the X-axis or Y-axis direction to the first polarization component PL1 (P-wave) and the second polarization component PL2 (S-wave) enables the formation of a line-shaped light distribution pattern. Furthermore, by adopting a voltage application pattern that diffuses the polarization component in the P-wave state along the X-axis and the polarization component in the S-wave state along the Y-axis for the first polarization component PL1 (P-wave) and the second polarization component PL2 (S-wave), a cross-shaped light distribution pattern can be formed. The number of liquid crystal panels constituting the liquid crystal light control element 102 is not limited to four and the number can be increased further. Furthermore, variations can be introduced in the stacking method of the liquid crystal panels. For example, the upper liquid crystal panel can be rotated at a predetermined angle to overlap the lower liquid crystal panel.

In the liquid crystal light control element 102 capable of such a configuration and operation, using an alignment film with a transmittance of 98% or higher at a wavelength of 450 nm suppresses degradation of the alignment film even when strong light from the light source is incident. This suppresses alignment disorder in the liquid crystal layer. Consequently, the reliability of the liquid crystal light control device 100 can be improved.

### EXAMPLES

The present invention will be described in more detail below with reference to examples and comparative examples. However, the invention is not limited to these examples, and various modifications are possible within the scope of the technical concept of the invention.

### Example 1

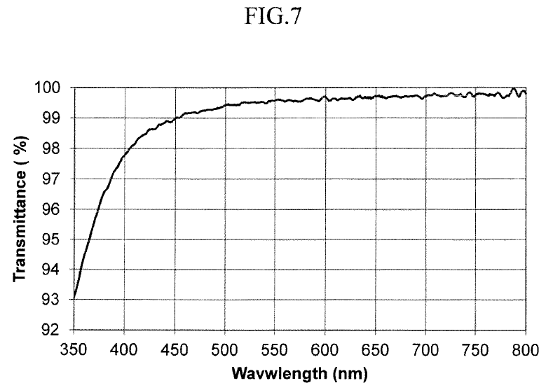

The solid component comprised the following Compound 1, the solvent component comprised N-methyl-2-pyrrolidone and butyl cellosolve, and the coloring component comprised the following Compound 2. The content ratio relative to the total amount of the solid component was 5 mol % (<10 mol %), and a varnish was formed. The varnish was coated onto a substrate and baked at 230° C. to obtain a 100 nm film. The obtained film was subjected to a rubbing treatment to yield comparative alignment film 1. The absorption spectrum of the obtained comparative alignment film 1 was measured using an ultraviolet-visible spectrophotometer (Hitachi High-Tech Corporation, model U-4100) over the range of 350 nm to 800 nm. FIG. 7 shows the absorption spectrum of the aligned film from Example 1. The transmittance of the aligned film from Example 1 at 450 nm was approximately 99%, which was higher than 98%.

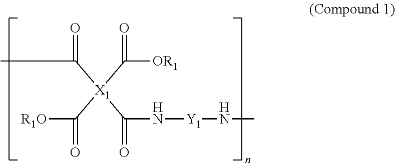

In the chemical formula of Compound 1, X₁ is the structural formula (X-18), Y₁ is the structural formula (Y1-21), R₁ is-H (hydrogen atom), and “n” is a positive integer.

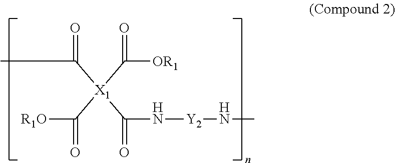

In the chemical formula of Compound 2, X₁ is the structural formula (X-18), Y₂ is the structural formula (Y2-5), R₁ is-H (hydrogen atom), and n is a positive integer.

### Comparative Example 1

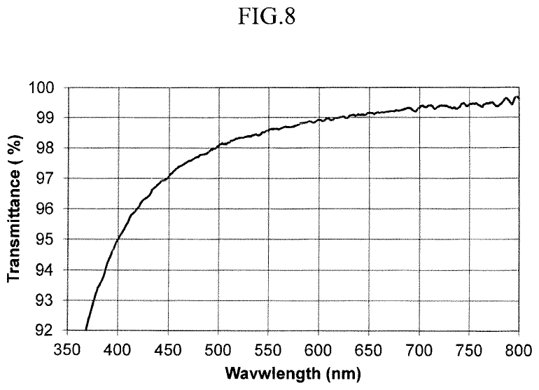

The above Compound 1 was used as the solid content, N-methyl-2-pyrrolidone and butyl cello solve were used as the solvent component, the above Compound 2 was used as the coloring component, the content ratio of the solid content to the whole was set to 30 mol % (>10 mol %), and the varnish was formed. The varnish was coated onto a substrate, baked at 230° C., yielding a 100 nm film. The obtained film was subjected to a rubbing treatment to obtain an alignment film 1. The absorption spectrum of the obtained alignment film was measured using an ultraviolet-visible spectrophotometer (Hitachi High-Tech Corporation, Model U-4100) over the range of 350 nm to 800 nm. FIG. 8 shows the absorption spectrum of the alignment film of Comparative Example 1. The transmittance of the alignment film of Comparative Example 1 at 450 nm was approximately 97%, which was lower than 98%.

What is claimed is:

1. A liquid crystal light control device comprising:
a pair of substrates;
a pair of alignment films between the pair of substrates, and
a liquid crystal layer between the pair of alignment films,
wherein each of the pair of substrates is provided with an electrode, and
at least one of the pair of alignment films has a transmittance of 98% or more at a wavelength of 450 nm.

2. The liquid crystal light control device according to claim 1,
wherein a varnish forming the alignment films includes a solid component and a solvent component,
the solid component includes a coloring material, and
a content ratio of the coloring material to a total amount of the solid component is less than 10 mol %.

3. The liquid crystal light control device according to claim 1,
wherein at least one of the pair of alignment films has a thickness of 20 nm or more and 200 nm or less.

4. The liquid crystal light control device according to claim 3,
wherein at least one of the pair of alignment films has a thickness of 40 nm or more and 150 nm or less.

5. The liquid crystal light control device according to claim 2,
wherein the solid component is composed of a photodecomposition component and a non-photodecomposition component,
a content of the photodecomposition component to a total amount of the solid component is 20% by mass or more and 50% by mass or less, and
a content of the non-photodecomposition component to a total amount of the solid component is 50% by mass or more and 80% by mass or less.

6. The liquid crystal light control device according to claim 5,
wherein a content ratio of the coloring material to a total amount of the photodecomposition component is less than 10 mol %, and
a content ratio of the coloring material to a total amount of the non-photodecomposition component is less than 10 mol %.

7. The liquid crystal light control device according to claim 2,
wherein the coloring material is a polyamic acid or a polyamic acid ester having a unit structure of the following chemical formula (4), 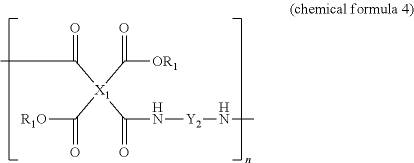
in the chemical formula (4),
X₁ is a tetravalent organic group,
Y₂ is a divalent organic group having an atom having electronegativity of 3 or more,
R₁ is a hydrogen atom or an alkyl group having 1 to 4 carbon atoms, and
n is a positive integer.

8. The liquid crystal light control device according to claim 7,
wherein the atom having electronegativity of 3 or more is selected from nitrogen (N), oxygen (O), fluorine (F), and chlorine (CI).

9. The liquid crystal light control device according to claim 7,
wherein the Y₂ is represented by the following chemical formula (5) or chemical formula (6), 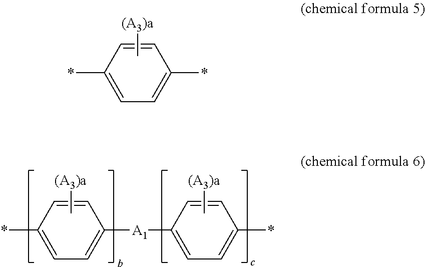
in the chemical formula (5) and chemical formula (6),
A₁ is a single bond, an ester bond, an amide bond, a thioester bond, or a divalent organic group having 2 to 20 carbon atoms,
A₃ represents an atom having electronegativity of 3 or more, a hydrogen atom, a halogen atom, a hydroxyl group, an amino group, a thiol group, a nitro group, a phosphoric acid group, or a monovalent organic group having 1 to 20 carbon atoms,
“a” is an integer of 1 to 4, and when “a” is 2 or more, A₃ is the same or different,
“b” and “c” are each independently an integer of 1 to 2,
when A₃ is singular, A₃ is an atom having electronegativity of 3 or more,
when A₃ is plural, at least one of As is an atom having electronegativity of 3 or more, and
* indicates a bonding position with nitrogen (N) adjacent to Y₂.

10. The liquid crystal light control device according to claim 9,
wherein Y₂ is represented by the following structural formulae (Y2-1) to (Y2-42), and
* indicates a bonding position with nitrogen (N) adjacent to Y₂.

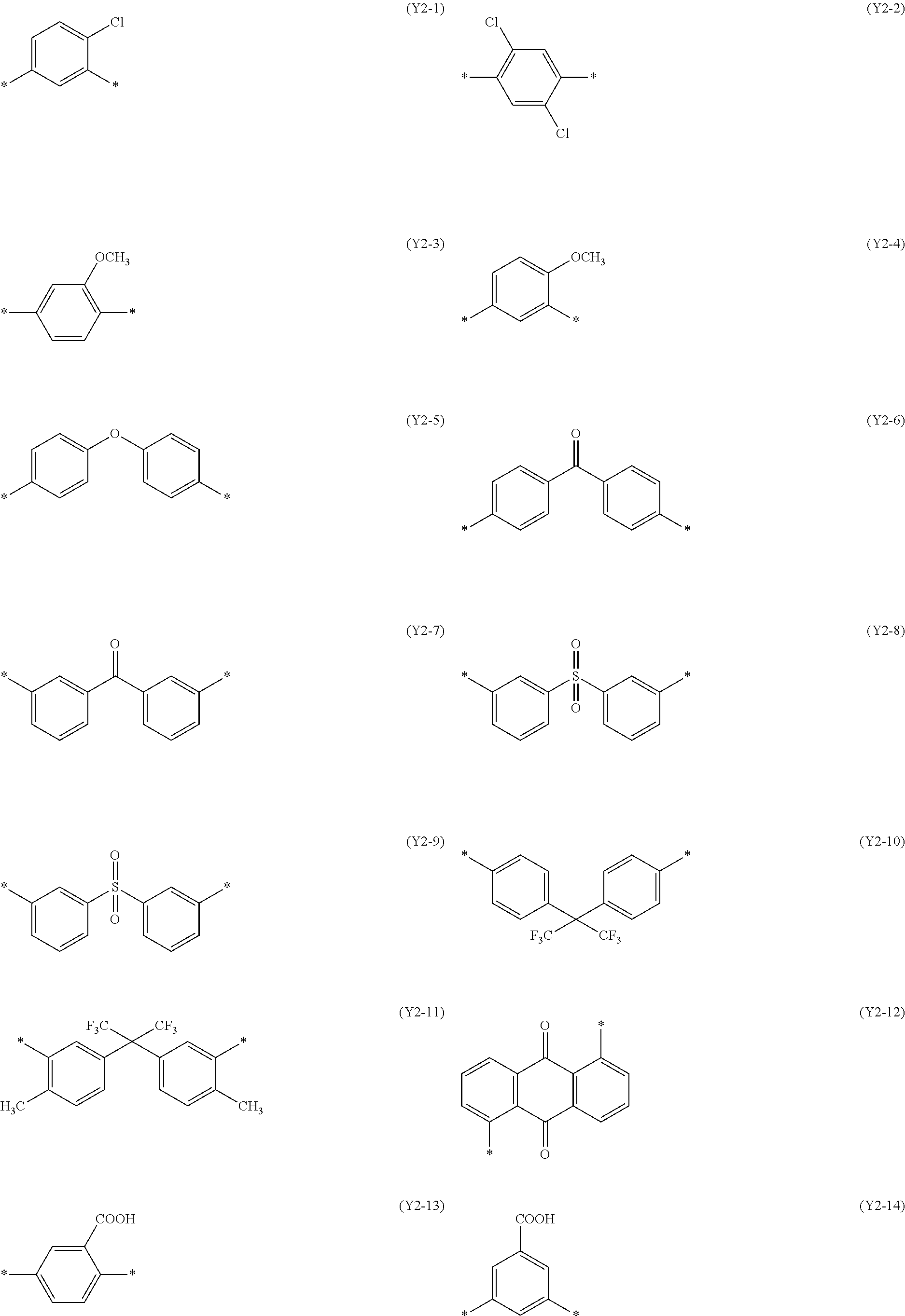

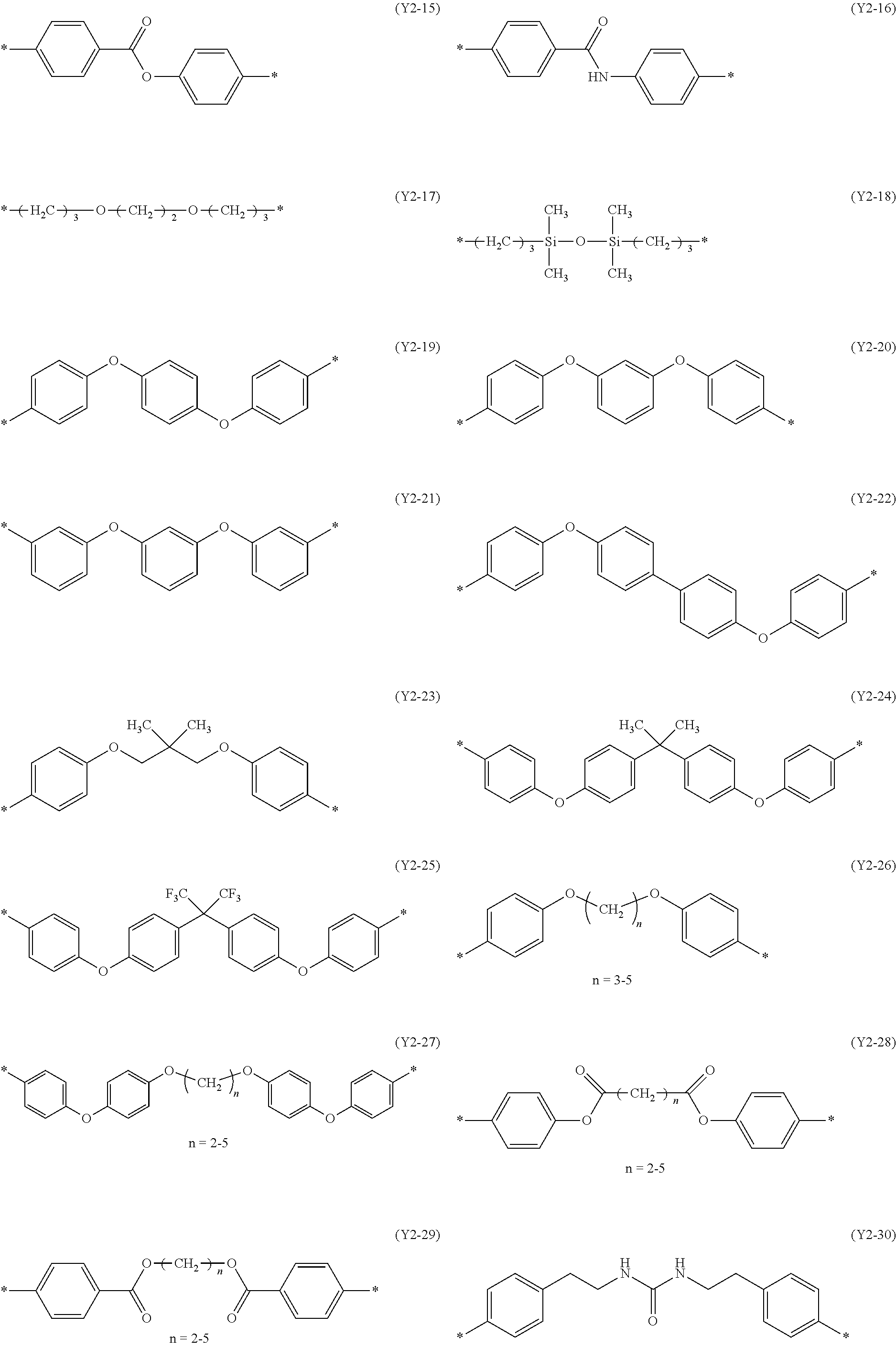

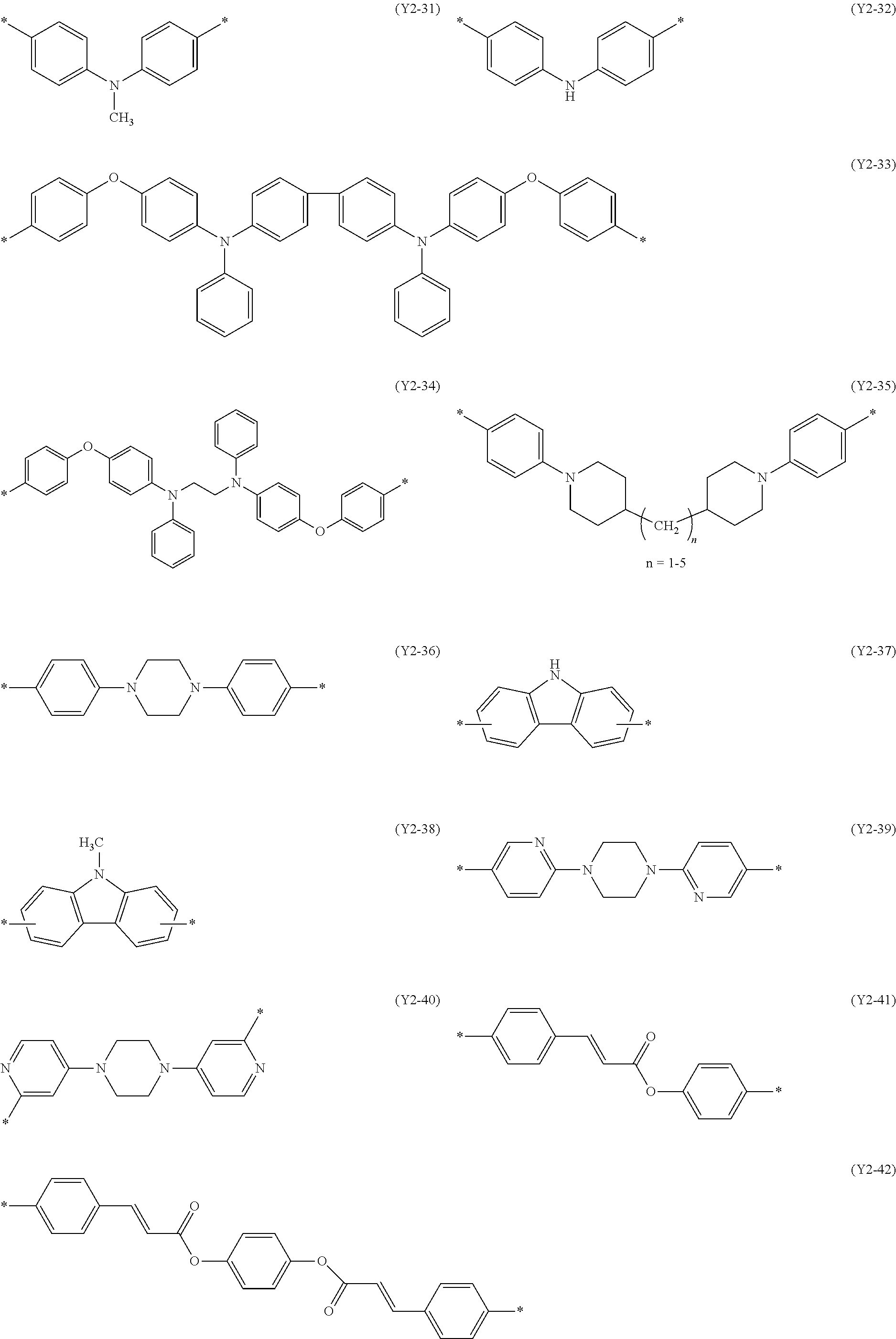

11. The liquid crystal light control device according to claim 5,
wherein the photodecomposition component is a polyamic acid or a polyamic acid ester having a unit structure of the following chemical formula (7), 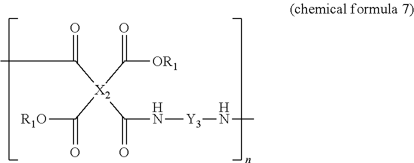
in the chemical formula (7),
X₂ is represented by the following structural formulae (X2-1) to (X2-4),
Y₃ is a divalent organic group,
R₁ is a hydrogen atom or an alkyl group having 1 to 4 carbon atoms, and
n is a positive integer, 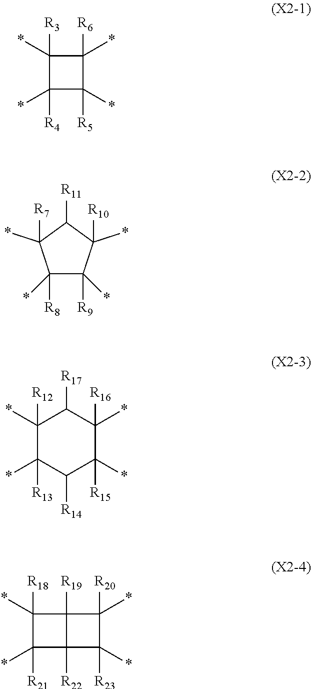
in the structural formulae (X 2-1) to (X 2-4),
R₃ to R₂₃ each independently represent a hydrogen atom, a halogen atom, an alkyl group having 1 to 6 carbon atoms, an alkenyl group having 2 to 6 carbon atoms, an alkynyl group having 2 to 6 carbon atoms, a monovalent organic group having 1 to 6 carbon atoms and containing a fluorine atom, or a phenyl group, and
* indicates a bonding position with carbon (C) adjacent to X₂.

12. The liquid crystal light control device according to claim 11,
wherein R₃ to R₂₃ are each represented by a hydrogen atom, a halogen atom, a methyl group, or an ethyl group in the structural formulae (X2-1) to (X2-4).

13. The liquid crystal light control device according to claim 11,
wherein R₃ to R₂₃ are each represented by a hydrogen atom, a methyl group, or an ethyl group in the structural formulae (X2-1) to (X2-4).

14. The liquid crystal light control device according to claim 11,
wherein the structural formula (X2-1) is represented by the following structural formulae (X2-11) to (X2-16),
* indicates a bonding position with carbon (C) adjacent to X₂.

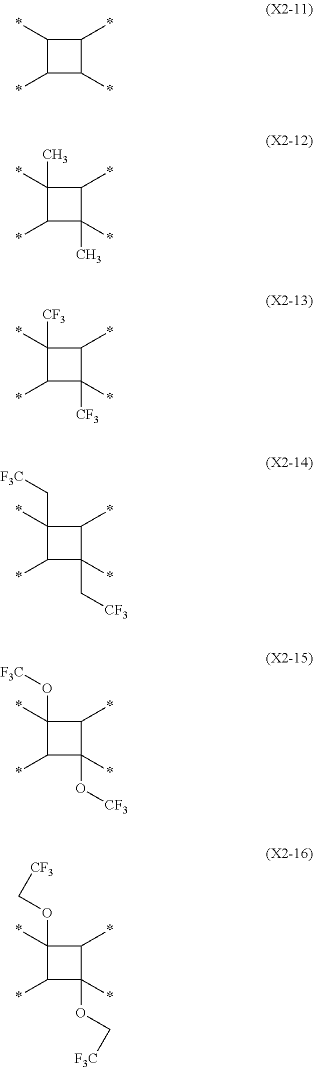

15. The liquid crystal light control device according to claim 11,
wherein the structural formula (X2-1) is represented by the following structural formulae (X2-11), (X2-12), and (X2-12 a).

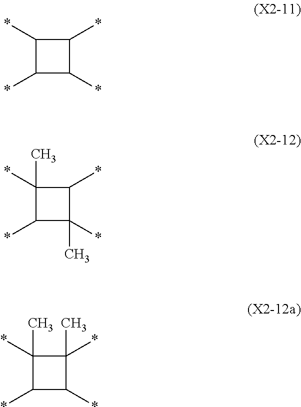

16. The liquid crystal light control device according to claim 5,
wherein the non-photodecomposition component is a polyamic acid or a polyamic acid ester having a unit structure of the following chemical formula (11), 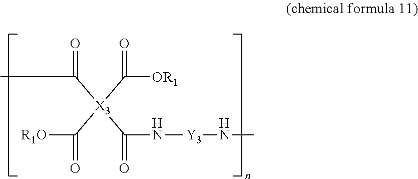
in the chemical formula (11),
X₃ is represented by the following structural formulae (X3-1) to (X3-22), and
Y₃ is a divalent organic group,
R₁ is a hydrogen atom or an alkyl group having 1 to 4 carbon atoms,
n is a positive integer,
* in the following structural formulae (X3-1) to (X3-22) is a bonding position with an adjacent carbon (C).

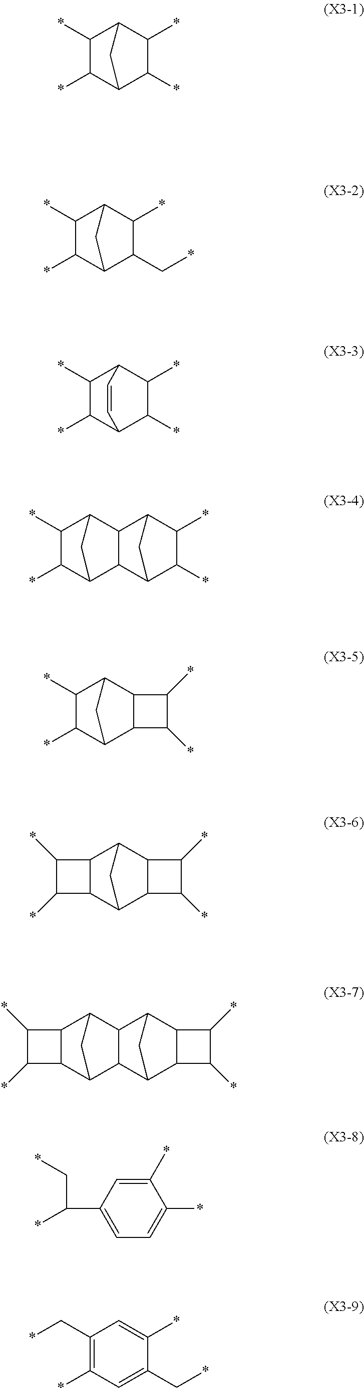

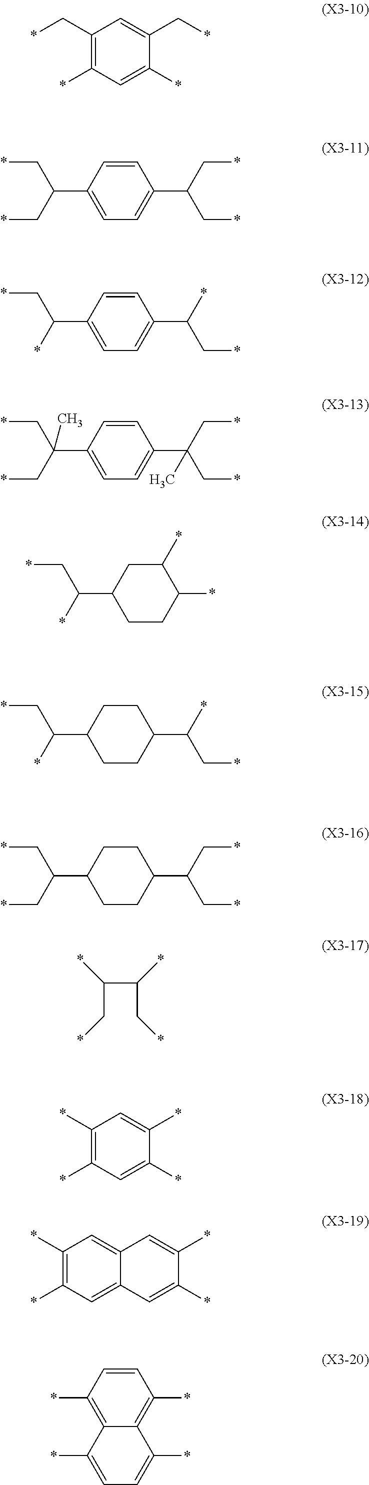

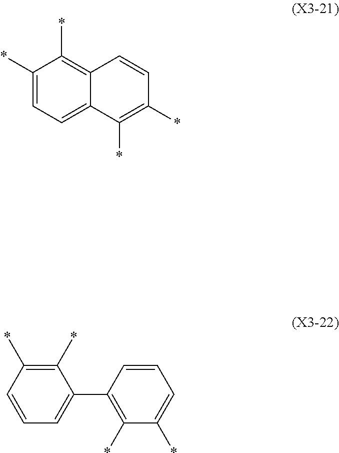 [SMILES: *c1ccc2c(*)c(*)ccc2c1* ; *c1cccc(-c2cccc(*)c2*)c1*]

17. The liquid crystal light control device according to claim 16,
wherein X₃ is represented by the structural formulae (X3-9), (X3-17), (X3-18), (X3-19), and (X3-20).

18. The liquid crystal light control device according to claim 16,
wherein X₃ is represented by the structural formulae (X3-18), (X3-19), and (X3-20).

19. The liquid crystal light control device according to claim 11,
wherein Y₃ is represented by the following chemical formula (8) or chemical formula (9), 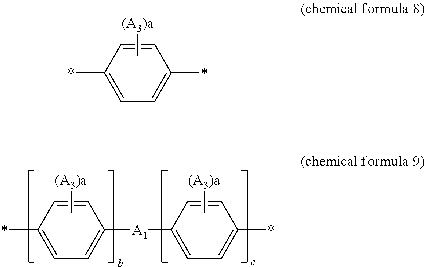
in the chemical formula (8) and chemical formula (9),
A₁ is a single bond, an ester bond, an amide bond, a thioester bond, or a divalent organic group having 2 to 20 carbon atoms,
A₃ represents an atom having electronegativity of 3 or more, a hydrogen atom, a halogen atom, a hydroxyl group, an amino group, a thiol group, a nitro group, a phosphoric acid group, or a monovalent organic group having 1 to 20 carbon atoms,
“a” is an integer of 1 to 4,
“b” and “c” are each independently an integer of 1 to 2, and
* is a bonding position with nitrogen (N) adjacent to Y₃.

20. The liquid crystal light control device according to claim 16,
wherein Y₃ is represented by the following chemical formula (8) or chemical formula (9), 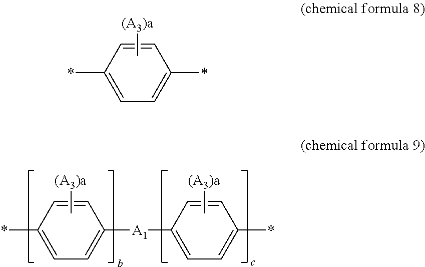
in the chemical formula (8) and chemical formula (9),
A₁ is a single bond, an ester bond, an amide bond, a thioester bond, or a divalent organic group having 2 to 20 carbon atoms,
A₃ represents an atom having electronegativity of 3 or more, a hydrogen atom, a halogen atom, a hydroxyl group, an amino group, a thiol group, a nitro group, a phosphoric acid group, or a monovalent organic group having 1 to 20 carbon atoms,
“a” is an integer of 1 to 4,
“b” and “c” are each independently an integer of 1 to 2, and
* is a bonding position with nitrogen (N) adjacent to Y₃.

21. The liquid crystal light control device according to claim 11,
wherein Y₃ is represented by the following structural formulae (Y3-1) to (Y3-38) and the following structural formulae (Y32-1) to (Y32-42), and
* is a bonding position with nitrogen (N) adjacent to Y₃ in the following structural formulae (Y3-1) to (Y3-38) and the following structural formulae (Y32-1) to (Y32-42).

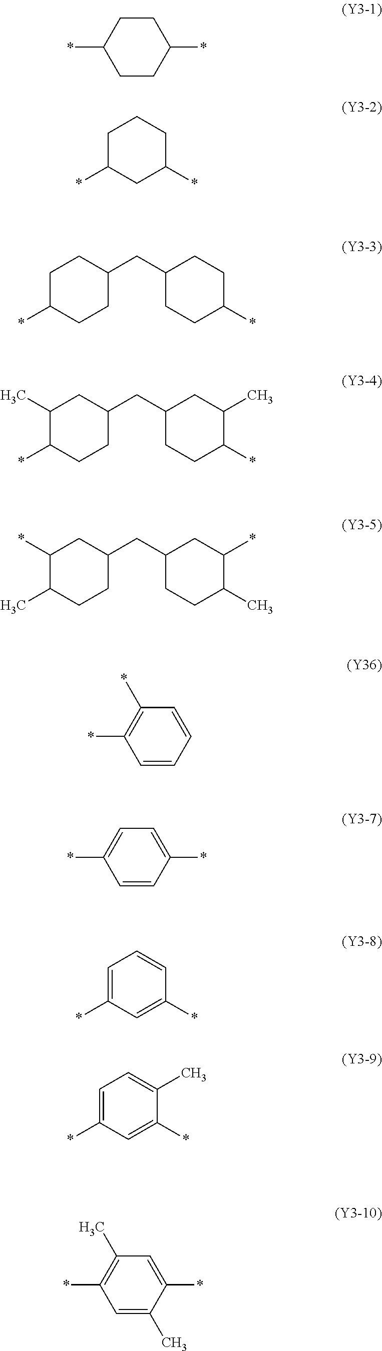

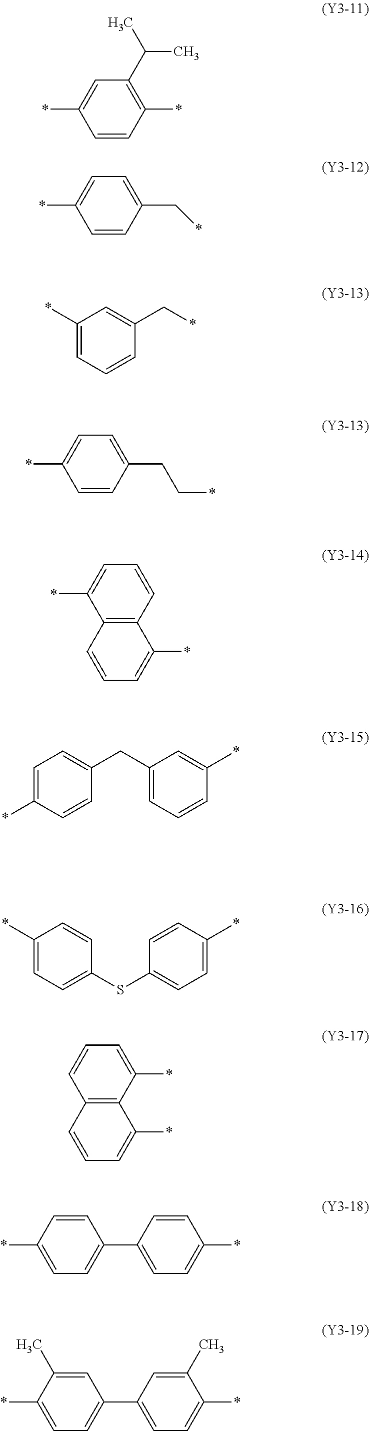

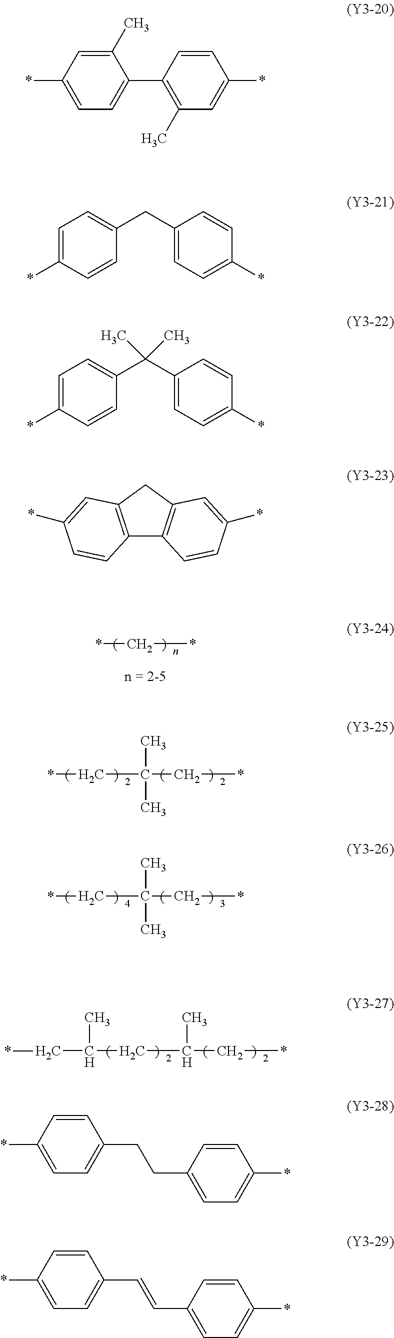

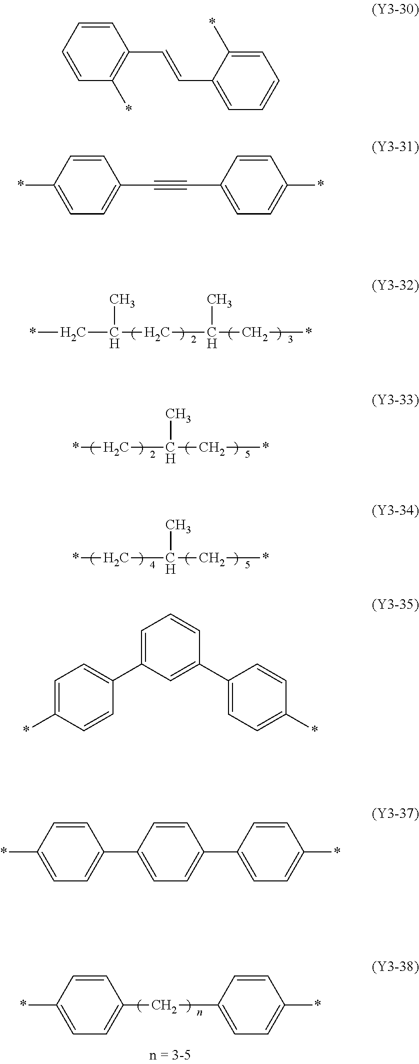

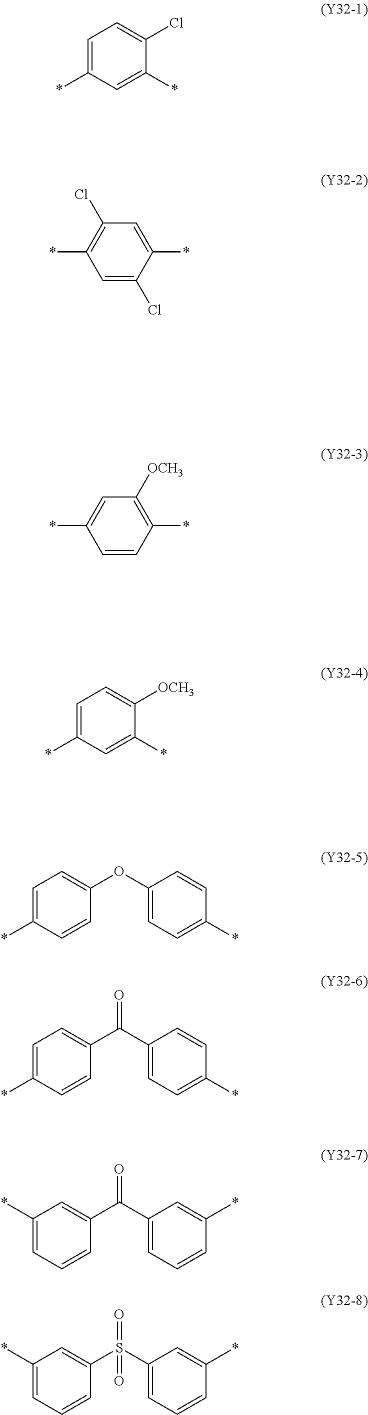

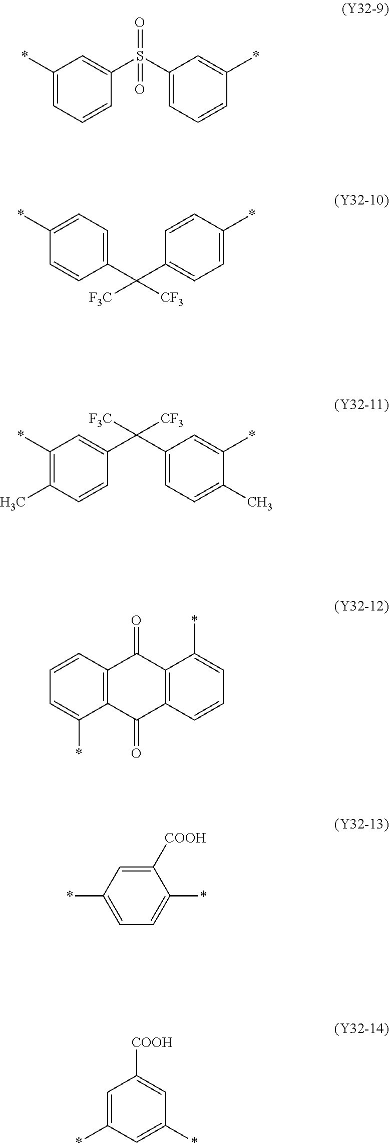 [SMILES: *c1cccc(S(=O)(=O)c2cccc(*)c2)c1 ; *c1ccc(C(c2ccc(*)cc2)(C(F)(F)F)C(F)(F)F)cc1 ; *c1cc(C(c2ccc(C)c(*)c2)(C(F)(F)F)C(F)(F)F)ccc1C ; *c1cccc2c1C(=O)c1cccc(*)c1C2=O ; *c1ccc(*)c(C(=O)O)c1 ; *c1cc(*)cc(C(=O)O)c1]

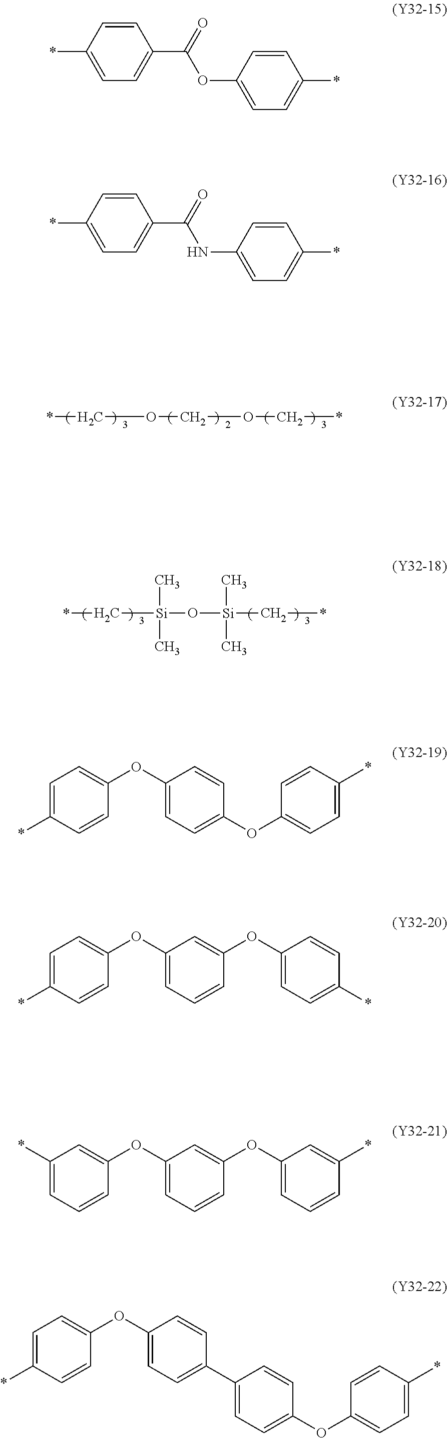

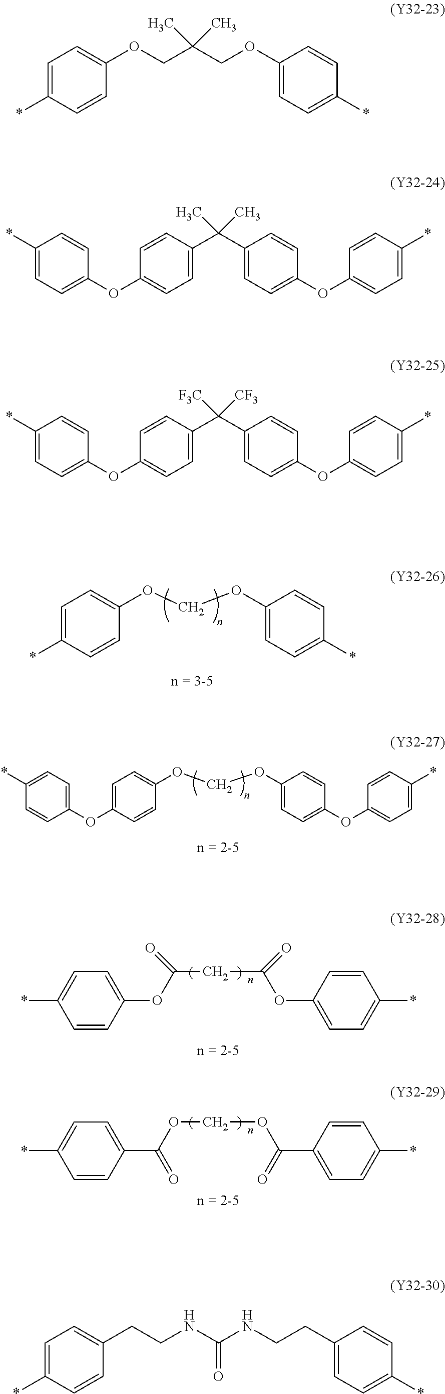

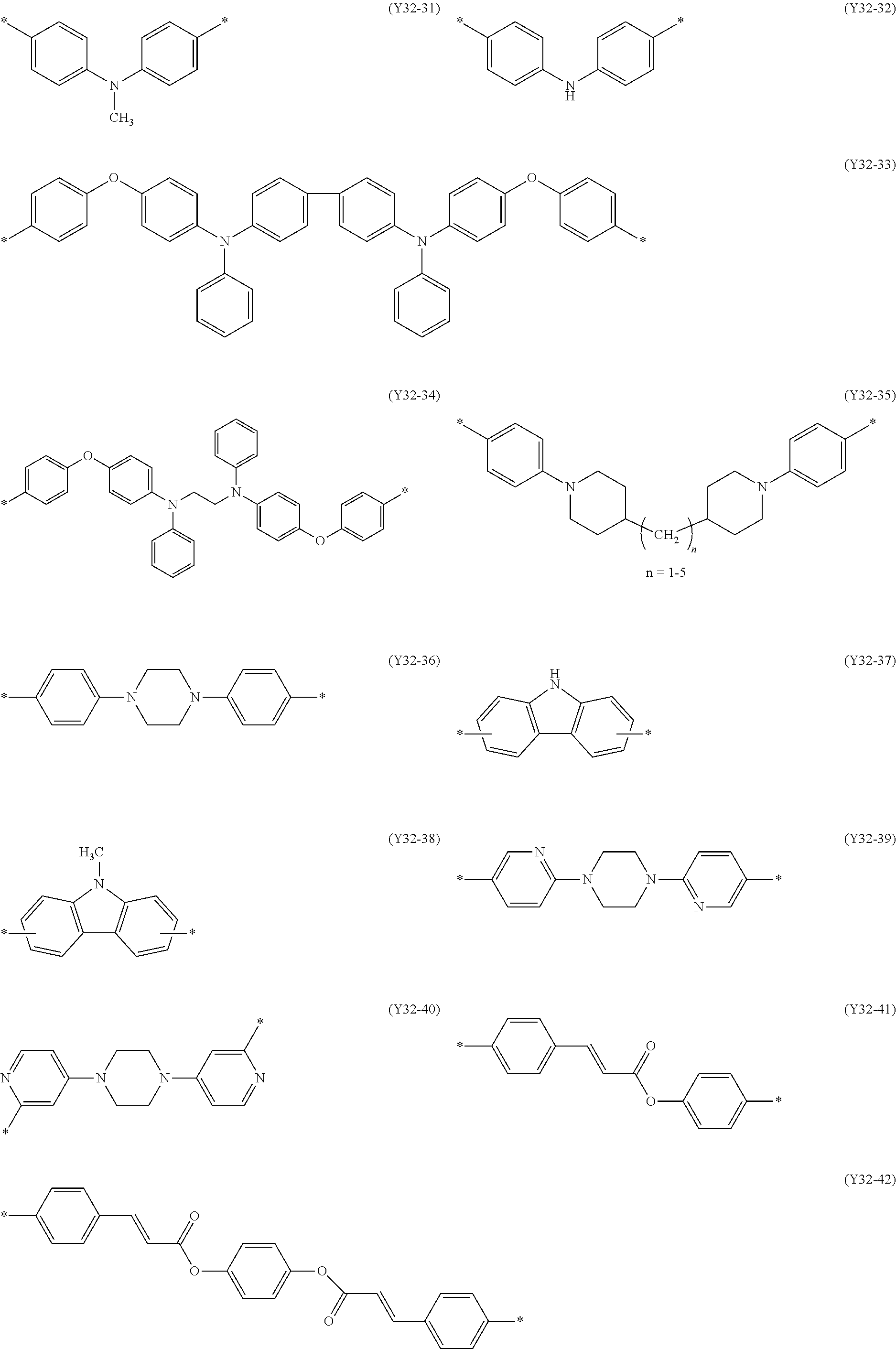

22. The liquid crystal light control device according to claim 16,
wherein Y₃ is represented by the following structural formulae (Y3-1) to (Y3-38) and the following structural formulae (Y32-1) to (Y32-42), and
* is a bonding position with nitrogen (N) adjacent to Y₃ in the following structural formulae (Y3-1) to (Y3-38) and the following structural formulae (Y32-1) to (Y32-42).

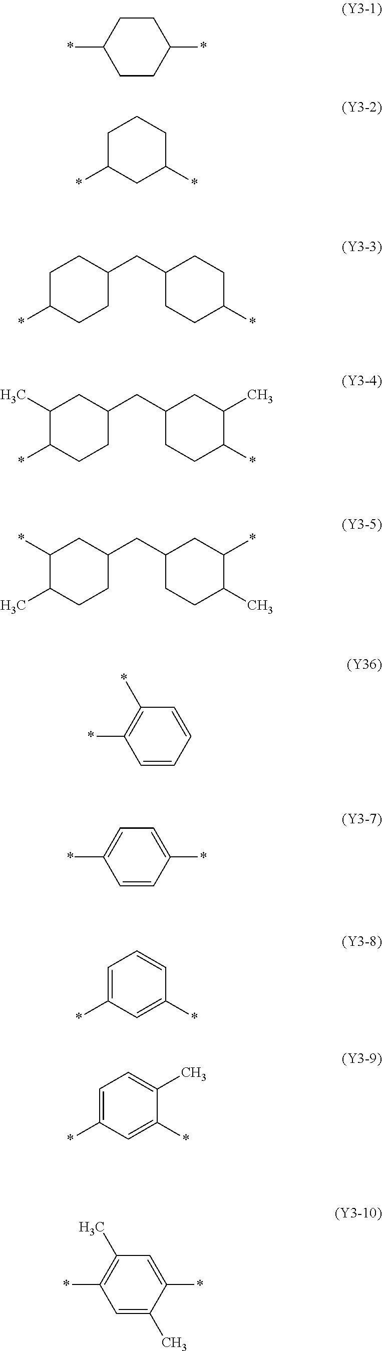

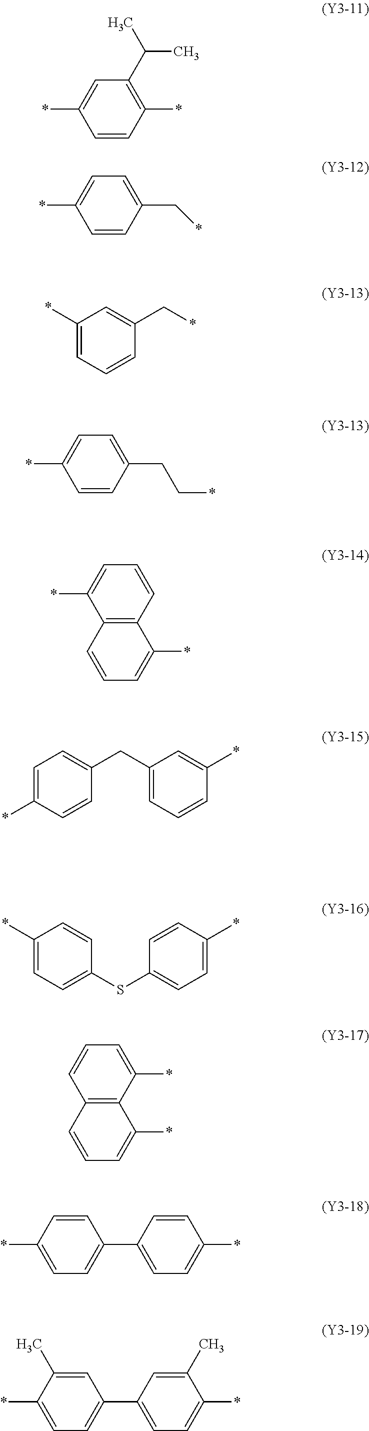

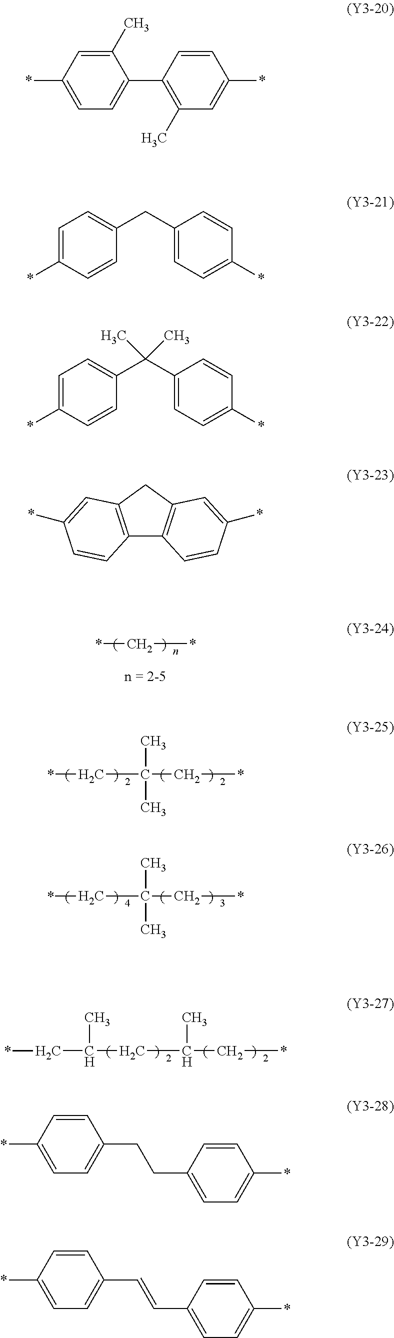

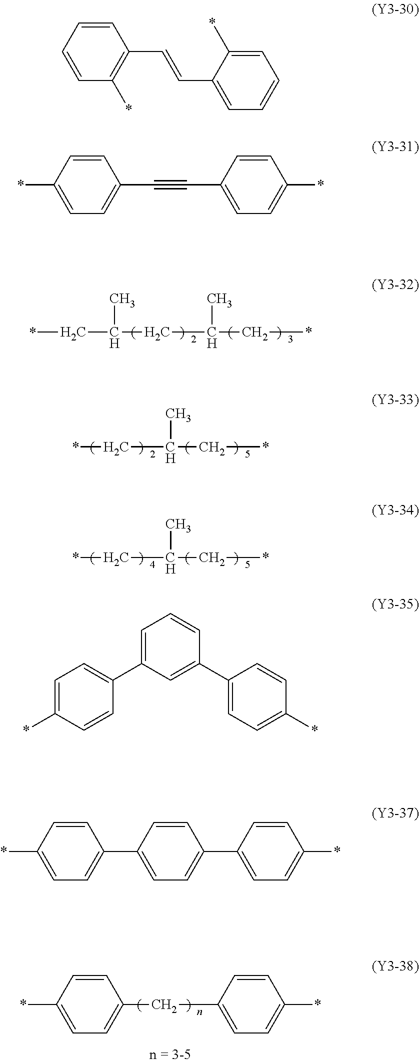

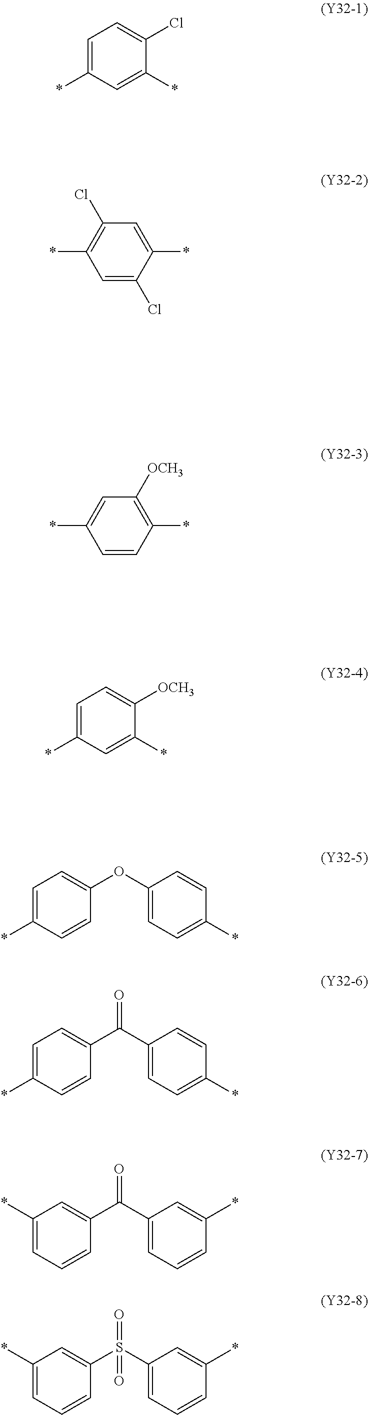

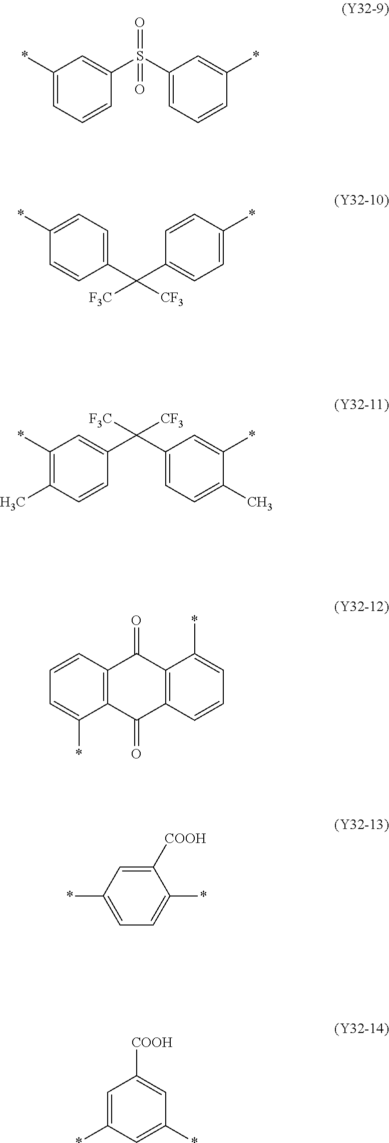 [SMILES: *c1cccc(S(=O)(=O)c2cccc(*)c2)c1 ; *c1ccc(C(c2ccc(*)cc2)(C(F)(F)F)C(F)(F)F)cc1 ; *c1cc(C(c2ccc(C)c(*)c2)(C(F)(F)F)C(F)(F)F)ccc1C ; *c1cccc2c1C(=O)c1cccc(*)c1C2=O ; *c1ccc(*)c(C(=O)O)c1 ; *c1cc(*)cc(C(=O)O)c1]

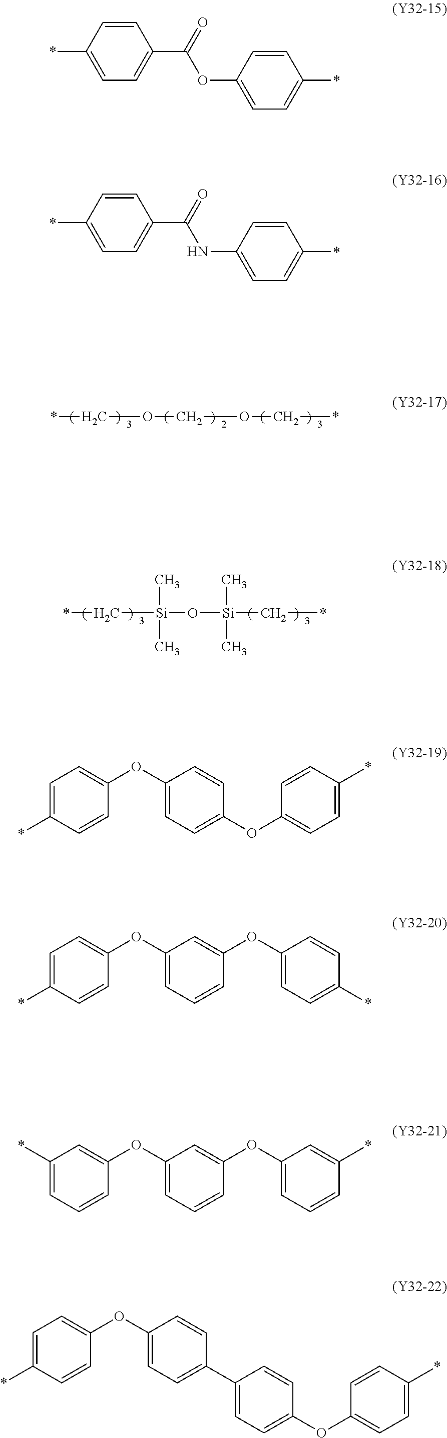

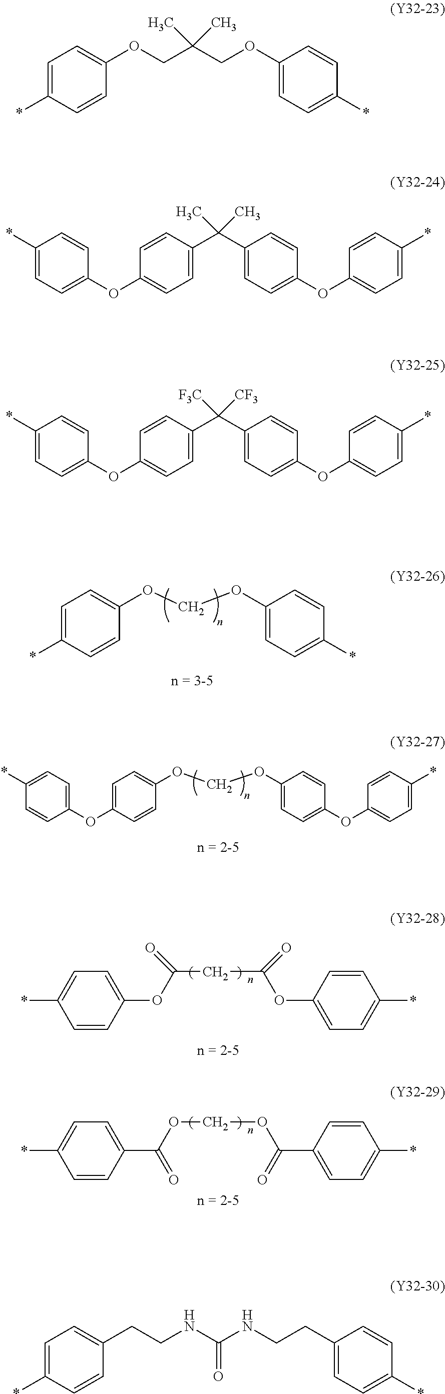

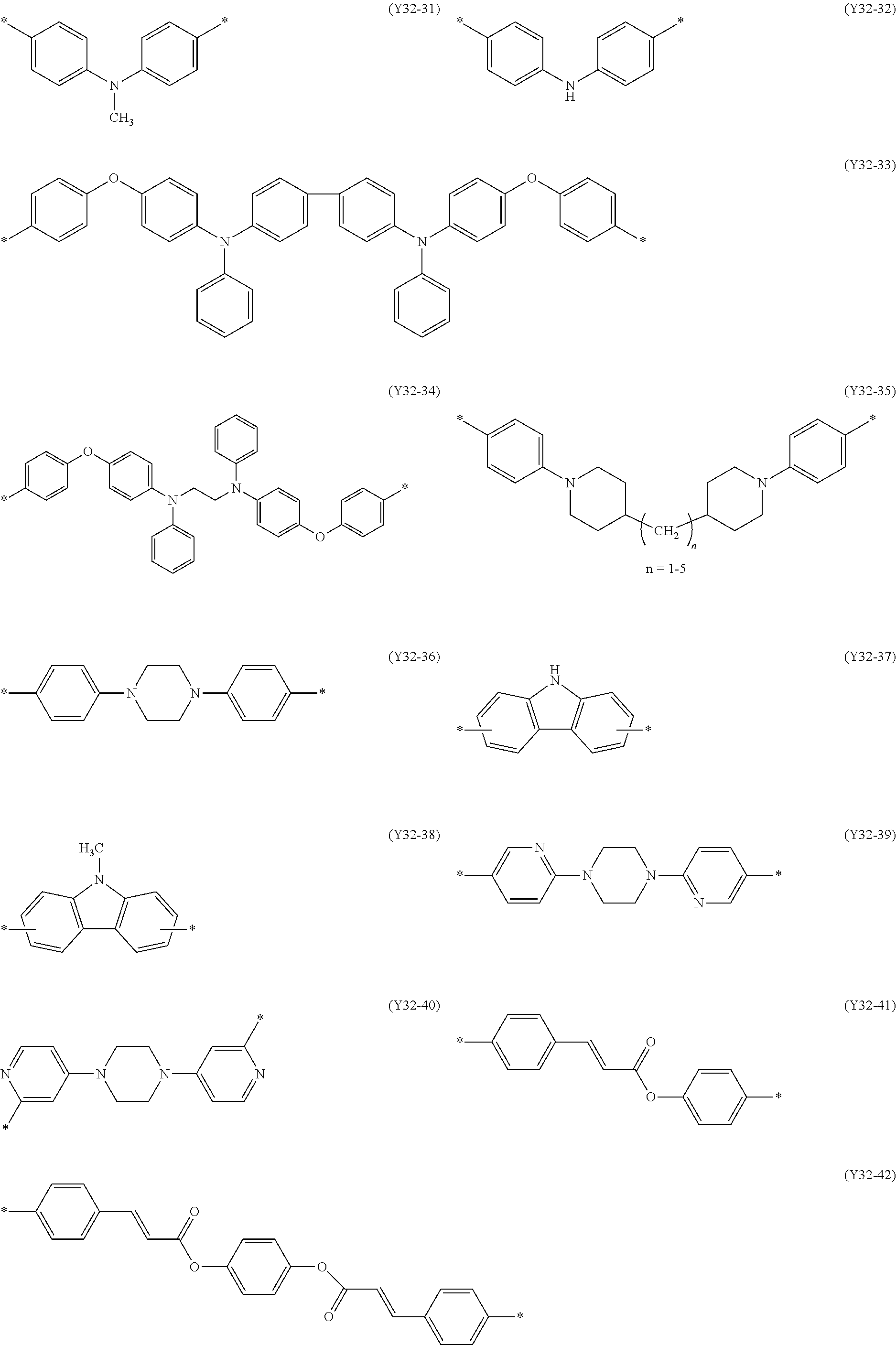

23. The liquid crystal light control device according to claim 2,
wherein the solid component of the varnish as a whole is 0.5 mass % or more and 15 mass % or less.

24. The liquid crystal light control device according to claim 21,
wherein the solid component of the varnish as a whole is 2% by mass or more and 10% by mass or less.

25. The liquid crystal light control device according to claim 2
wherein the solvent component of the varnish includes a good solvent and a solvent having a lower surface tension than the good solvent, and
a content of the solvent having a low surface tension with respect to a total amount of the varnish is 10% by weight or more and 40% by weight or less.
